(19) United States
(12) Patent Application Publication
(10) Pub. No.: US 2016/0091451 A1
(43) Pub. Date: Mar. 31, 2016

(54) ACCURATE ANALYTE MEASUREMENTS FOR ELECTROCHEMICAL TEST STRIP TO DETERMINE ANALYTE MEASUREMENT TIME BASED ON MEASURED TEMPERATURE, PHYSICAL CHARACTERISTIC AND ESTIMATED ANALYTE VALUE

(71) Applicant: LifeScan Scotland Limited, Inverness (GB)

(72) Inventors: David MCCOLL, Inverness (GB); Antony SMITH, Inverness (GB)

(21) Appl. No.: 14/496,464

(22) Filed: Sep. 25, 2014

(51) Int. Cl. G01N 27/327

(52) U.S. Cl. CPC G01N 27/3274; G01N 27/3272; G01N 27/3273

(57) ABSTRACT

Various embodiments for a method that allow for a more accurate analyte concentration with a biosensor by determining at least one physical characteristic signal representative of the sample containing the analyte and selecting an analyte measurement sampling time based on measured temperature, physical characteristic and estimated analyte values.

### BACKGROUND

Electrochemical glucose test strips, such as those used in the OneTouch® Ultra® whole blood testing kit, which is available from LifeScan, Inc., are designed to measure the concentration of glucose in a physiological fluid sample from patients with diabetes. The measurement of glucose can be based on the selective oxidation of glucose by the enzyme glucose oxidase (GO). The reactions that can occur in a glucose test strip are summarized below in Equations 1 and 2.

Glucose+GO₍ₒₓ₎→Gluconic Acid+GO_{(red)} Eq. 1

GO_{(red)}+2Fe(CN)₆³⁻→GO₍ₒₓ₎+2Fe(CN)₆⁴⁻ Eq. 2

As illustrated in Equation 1, glucose is oxidized to gluconic acid by the oxidized form of glucose oxidase (GO₍ₒₓ₎). It should be noted that GO₍ₒₓ₎ may also be referred to as an “oxidized enzyme.” During the reaction in Equation 1, the oxidized enzyme GO₍ₒₓ₎ is converted to its reduced state, which is denoted as GO_{(red)} (i.e., “reduced enzyme”). Next, the reduced enzyme GO_{(red)} is re-oxidized back to GO₍ₒₓ₎ by reaction with Fe(CN)₆³⁻ (referred to as either the oxidized mediator or ferricyanide) as illustrated in Equation 2. During the re-generation of GO_{(red)} back to its oxidized state GO₍ₒₓ₎, Fe(CN)₆³⁻ is reduced to Fe(CN)₆⁴⁻ (referred to as either reduced mediator or ferrocyanide).

When the reactions set forth above are conducted with a test signal applied between two electrodes, a test current can be created by the electrochemical re-oxidation of the reduced mediator at the electrode surface. Thus, since, in an ideal environment, the amount of ferrocyanide created during the chemical reaction described above is directly proportional to the amount of glucose in the sample positioned between the electrodes, the test current generated would be proportional to the glucose content of the sample. A mediator, such as ferricyanide, is a compound that accepts electrons from an enzyme such as glucose oxidase and then donates the electrons to an electrode. As the concentration of glucose in the sample increases, the amount of reduced mediator formed also increases; hence, there is a direct relationship between the test current, resulting from the re-oxidation of reduced mediator, and glucose concentration. In particular, the transfer of electrons across the electrical interface results in the flow of a test current (2 moles of electrons for every mole of glucose that is oxidized). The test current resulting from the introduction of glucose can, therefore, be referred to as a glucose signal.

Electrochemical biosensors may be adversely affected by the presence of certain blood components that may undesirably affect the measurement and lead to inaccuracies in the detected signal. This inaccuracy may result in an inaccurate glucose reading, leaving the patient unaware of a potentially dangerous blood sugar level, for example. As one example, the blood hematocrit level (i.e. the percentage of the amount of blood that is occupied by red blood cells) can erroneously affect a resulting analyte concentration measurement.

Variations in a volume of red blood cells within blood can cause variations in glucose readings measured with disposable electrochemical test strips. Typically, a negative bias (i.e., lower calculated analyte concentration) is observed at high hematocrit, while a positive bias (i.e., higher calculated analyte concentration) is observed at low hematocrit. At high hematocrit, for example, the red blood cells may impede the reaction of enzymes and electrochemical mediators, reduce the rate of chemistry dissolution since there is less plasma volume to solvate the chemical reactants, and slow diffusion of the mediator. These factors can result in a lower than expected glucose reading as less signal is produced during the electrochemical process. Conversely, at low hematocrit, fewer red blood cells may affect the electrochemical reaction than expected, and a higher measured signal can result. In addition, the physiological fluid sample resistance is also hematocrit dependent, which can affect voltage and/or current measurements.

Several strategies have been used to reduce or avoid hematocrit based variations on blood glucose. For example, test strips have been designed to incorporate meshes to remove red blood cells from the samples, or have included various compounds or formulations designed to increase the viscosity of red blood cells and attenuate the effect of low hematocrit on concentration determinations. Other test strips have included lysis agents and systems configured to determine hemoglobin concentration in an attempt to correct hematocrit. Further, biosensors have been configured to measure hematocrit by measuring an electrical response of the fluid sample via alternating current signals or change in optical variations after irradiating the physiological fluid sample with light, or measuring hematocrit based on a function of sample chamber fill time. These sensors have certain disadvantages. A common technique of the strategies involving detection of hematocrit is to use the measured hematocrit value to correct or change the measured analyte concentration, which technique is generally shown and described in the following respective US Patent Application Publication Nos. 2010/0283488; 2010/0206749; 2009/0236237; 2010/0276303; 2010/0206749; 2009/0223834; 2008/0083618; 2004/0079652; 2010/0283488; 2010/0206749; 2009/0194432; or U.S. Pat. Nos. 7,972,861 and 7,258,769, all of which are incorporated by reference herein to this application.

### SUMMARY OF THE DISCLOSURE

We have devised an improved technique (and variations thereon) to measure analyte concentration such that the analyte concentration is less sensitive to temperature to an analyte estimate and the physical characteristic (e.g., viscosity or hematocrits) of the fluid sample. In one embodiment, we have devised an analyte measurement system that includes a test strip and an analyte meter. The test strip includes a plurality of electrodes connected to respective electrode connectors. The meter includes a housing with a test strip port connector configured to connect to the respective electrode connectors of the test strip and a microprocessor in electrical communication with the test strip port connector to apply electrical signals or sense electrical signals from the plurality of electrodes during a test sequence. The microprocessor is configured, during the test sequence, to: (a) start an analyte test sequence upon deposition of a sample; (b) apply a signal to the sample to determine a physical characteristic signal representative of the sample; (c) drive another signal to the sample; (d) measure at least one output signal from at least one of the electrodes; (e) measure a temperature of one of the sample, test strip, or meter; (f) determine a temperature compensated value for the physical characteristic signal based on the measured temperature; (g) derive an estimated analyte concentration from the at least one output signal at one of a plurality of predetermined time intervals as referenced from the start of the test sequence; (h) determine a temperature compensated value for the estimated analyte concentration based on the measured temperature; (i) select an analyte measurement sampling time point or time interval with respect to the start of the test sequence based on (1) the temperature compensated value of the physical characteristic signal and (2) the temperature compensated value of the estimated analyte concentration; (j) calculate an analyte concentration based on a magnitude of the output signals at the selected analyte measurement sampling time point or time interval; and (k) annunciate the analyte concentration.

In yet another embodiment, we have devised an analyte measurement system that includes a test strip and an analyte meter. The test strip includes a plurality of electrodes connected to respective electrode connectors. The meter includes a housing with a test strip port connector configured to connect to the respective electrode connectors of the test strip and a microprocessor in electrical communication with the test strip port connector to apply electrical signals or sense electrical signals from the plurality of electrodes during a test sequence. The microprocessor is configured, during the test sequence, to: (a) start an analyte test sequence upon deposition of a sample; (b) apply a signal to the sample to determine a physical characteristic signal representative of the sample; (c) drive another signal to the sample; (d) measure at least one output signal from at least one of the electrodes; (e) measure a temperature of one of the sample, test strip, or meter; (f) derive an estimated analyte concentration from the at least one output signal at one of a plurality of predetermined time intervals as referenced from the start of the test sequence; (g) selecting an analyte measurement sampling time point or time interval with respect to the start of the test sequence based on: (1) the measured temperature, (2) the physical characteristic signal, (3) the estimated analyte concentration; (i) calculate an analyte concentration based on a magnitude of the output signals at the selected analyte measurement sampling time point or time interval; and (j) annunciate the analyte concentration.

In yet a further embodiment, we have devised an analyte measurement system that includes a test strip and an analyte meter. The test strip includes a plurality of electrodes connected to respective electrode connectors. The meter includes a housing with a test strip port connector configured to connect to the respective electrode connectors of the test strip and a microprocessor in electrical communication with the test strip port connector to apply electrical signals or sense electrical signals from the plurality of electrodes during a test sequence. The microprocessor is configured, during the test sequence, to: (a) start an analyte test sequence upon deposition of a sample; (b) apply a signal to the sample to determine a physical characteristic signal of the sample; (c) drive another signal to the sample; (d) measure at least one output signal from at least one of the electrodes; (e) measure a temperature of one of the sample, test strip, or meter; (f) derive an estimated analyte concentration from the at least one output signal at one of a plurality of predetermined time intervals as referenced from the start of the test sequence; (g) determine whether the measured temperature is in one of a plurality of temperature ranges; (h) select an analyte measurement sampling time based on the estimated analyte concentration and the physical characteristic signal representative of the sample in a selected one of a plurality of temperature ranges; (i) calculate an analyte concentration based on a magnitude of the output signals at the analyte measurement sampling time or time interval from the selected analyte measurement sampling time map; and (j) annunciate the analyte concentration.

In yet another embodiment, we have devised a method of determining an analyte concentration from a fluid sample with a test strip having at least two electrodes and a reagent disposed on at least one of the electrodes. The method can be achieved by depositing a fluid sample on any one of the at least two electrodes to start an analyte test sequence; applying a first signal to the sample to measure a physical characteristic of the sample; driving a second signal to the sample to cause an enzymatic reaction of the analyte and the reagent; estimating an analyte concentration based on a predetermined sampling time point from the start of the test sequence; measuring temperature of at least one of the biosensor or ambient environment; obtaining a look up table from a plurality of look-up table indexed to the measured temperature, each look-up table having different qualitative categories of the estimated analyte and different qualitative categories of the measured or estimated physical characteristic indexed against different sampling time points; selecting a sampling time point from the look-up table obtained in the obtaining step; sampling signal output from the sample at the selected measurement sampling time from the look-up table obtained in the obtaining step; calculating an analyte concentration from measured output signal sampled at said selected measurement sampling time in accordance with an equation of the form:

$${G}_{0} = [ \frac{{I}_{T} - Intercept}{Slope} ]$$

where
G₀ represents an analyte concentration;
I_{T} represents a signal (proportional to analyte concentration) measured at the selected sampling time T;
Slope represents the value obtained from calibration testing of a batch of test strips of which this particular strip comes from; and
Intercept represents the value obtained from calibration testing of a batch of test strips of which this particular strip comes from.

In yet a further variation, we have devised a method of determining an analyte concentration from a fluid sample with a test strip having at least two electrodes and a reagent disposed on at least one of the electrodes. The method can be achieved by depositing a fluid sample on a biosensor to start a test sequence; causing the analyte in the sample to undergo an enzymatic reaction; estimating an analyte concentration in the sample; measuring at least one physical characteristic of the sample; measuring temperature of at least one of the biosensor or ambient environment; obtaining a look up table from a plurality of look-up table indexed to the measured temperature, each look-up table having different qualitative categories of the estimated analyte and different qualitative categories of the measured or estimated physical characteristic indexed against different sampling time points; selecting a sampling time point from the look-up table obtained in the obtaining step; sampling signal output from the sample at the selected measurement sampling time from the look-up table obtained in the obtaining step; and determining an analyte concentration from sampled signals at the selected measurement sampling time.

And for these aspects, the following features may also be utilized in various combinations with these previously disclosed aspects: the obtaining may include driving a second signal to the sample to derive a physical characteristic signal representative of the sample; the applying may include applying a first signal to the sample to derive a physical characteristic signal representative of the sample, and the applying of the first signal and the driving of the second signal may be in sequential order; the applying of the first signal may overlap with the driving of the second signal; the applying may comprise applying a first signal to the sample to derive a physical characteristic signal representative of the sample, and the applying of the first signal may overlap with the driving of the second signal; the applying of the first signal may include directing an alternating signal to the sample so that a physical characteristic signal representative of the sample is determined from an output of the alternating signal; the applying of the first signal may include directing an optical signal to the sample so that a physical characteristic signal representative of the sample is determined from an output of the optical signal; the physical characteristic signal may include hematocrit and the analyte may include glucose; the physical characteristic signal may include at least one of viscosity, hematocrit, temperature and density; the directing may include driving first and second alternating signal at different respective frequencies in which a first frequency is lower than the second frequency; the first frequency may be at least one order of magnitude lower than the second frequency; the first frequency may include any frequency in the range of about 10 kHz to about 250 kHz, or about 10 kHz to about 90 kHz; and/or the specified analyte measurement sampling time may be calculated using an equation of the form:

SpecifiedSamplingTime=x₁H^{x}^{₂}+x₃

where

“SpecifiedSamplingTime” is designated as a time point from the start of the test sequence at which to sample the output signal (e.g. output signal) of the test strip,

H represents, or is physical characteristic signal representative of the sample;

x₁ is about 4.3e5, or is equal to 4.3e5, or is equal to 4.3e5+/−10%, 5% or 1% of the numerical value provided hereof;

x₂ is about −3.9, or is equal to −3.9, or is equal to −3.9+/−10%, 5% or 1% of the numerical value provided hereof; and

x₃ is about 4.8, or is equal to 4.8, or is equal to 4.8+/−10%, 5% or 1% of the numerical value provided herein.

It is noted that the analyte measurement sampling time point could be selected from a look-up table that includes a matrix in which different qualitative categories of the estimated analyte are set forth in the leftmost column of the matrix and different qualitative categories of the measured or estimated physical characteristic signal are set forth in the topmost row of the matrix and the analyte measurement sampling times are provided in the remaining cells of the matrix. In any of the above aspects, the fluid sample may be blood. In any of the above aspects, the physical characteristic signal may include at least one of viscosity, hematocrit, or density of the sample, or the physical characteristic signal may be hematocrit, wherein, optionally, the hematocrit level is between 30% and 55%. In any of the above aspects, where H represents, or is, the physical characteristic signal representative of the sample, it may be the measured, estimated or determined hematocrit, or may be in the form of hematocrit. In any of the above aspects, the physical characteristic signal may be determined from a measured characteristic, such as the impedance or phase angle of the sample. In any of the above aspects, the signal represented by I_{E} and/or I_{T} may be current.

In the aforementioned aspects of the disclosure, the steps of determining, estimating, calculating, computing, deriving and/or utilizing (possibly in conjunction with an equation) may be performed by an electronic circuit or a processor. These steps may also be implemented as executable instructions stored on a computer readable medium; the instructions, when executed by a computer may perform the steps of any one of the aforementioned methods.

In additional aspects of the disclosure, there are computer readable media, each medium comprising executable instructions, which, when executed by a computer, perform the steps of any one of the aforementioned methods.

In additional aspects of the disclosure, there are devices, such as test meters or analyte testing devices, each device or meter comprising an electronic circuit or processor configured to perform the steps of any one of the aforementioned methods.

These and other embodiments, features and advantages will become apparent to those skilled in the art when taken with reference to the following more detailed description of the exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements), in which:

FIG. 1 illustrates an analyte measurement system.

FIG. 2A illustrates in simplified schematic form the components of the meter 200.

FIG. 2B illustrates in simplified schematic form a preferred implementation of a variation of meter 200.

FIG. 3A(1) illustrates the test strip 100 of the system of FIG. 1 in which there are two physical characteristic signal sensing electrodes upstream of the measurement electrodes.

FIG. 3A(2) illustrates a variation of the test strip of FIG. 3A(1) in which a shielding or grounding electrode is provided for proximate the entrance of the test chamber;

FIG. 3A(3) illustrates a variation of the test strip of FIG. 3A(2) in which a reagent area has been extended upstream to cover at least one of the physical characteristic signal sensing electrodes;

FIG. 3A(4) illustrates a variation of test strip 100 of FIGS. 3A(1), 3A(2) and 3A(3) in which certain components of the test strip have been integrated together into a single unit;

FIG. 3B illustrates a variation of the test strip of FIG. 3A(1), 3A(2), or 3A(3) in which one physical characteristic signal sensing electrode is disposed proximate the entrance and the other physical characteristic signal sensing electrode is at the terminal end of the test cell with the measurement electrodes disposed between the pair of physical characteristic signal sensing electrodes.

FIGS. 3C and 3D illustrate variations of FIG. 3A(1), 3A(2), or 3A(3) in which the physical characteristic signal sensing electrodes are disposed next to each other at the terminal end of the test chamber with the measurement electrodes upstream of the physical characteristic signal sensing electrodes.

FIGS. 3E and 3F illustrates a physical characteristic signal sensing electrodes arrangement similar to that of FIG. 3A(1), 3A(2), or 3A(3) in which the pair of physical characteristic signal sensing electrodes are proximate the entrance of the test chamber.

FIG. 4A illustrates a graph of time over applied potential to the test strip of FIG. 1.

FIG. 4B illustrates a graph of time over output current from the test strip of FIG. 1.

FIG. 5A illustrates a problem encountered to the analyte due to the hematocrit in blood samples becoming sensitive to changes in environmental (e.g., ambient) or on the meter itself when a known analyte measurement technique was utilized.

FIG. 5B illustrates a similar problem with our earlier technique described in our earlier patent applications.

FIG. 5C illustrates the sensitivity of the impedance characteristic to temperature for our exemplary biosensor.

FIG. 5D illustrates that the biases or errors at 42% hematocrit for various glucose concentrations are also related to temperature.

FIG. 6 illustrates a logic diagram of an exemplary method to achieve a more accurate analyte determination by correcting for temperature sensitivity.

FIG. 7 illustrates a logic diagram of a variation on the technique shown in FIG. 6.

FIG. 8 illustrates a typical transient output signal measured from the enzymatic electrochemical reaction in the test chamber of the biosensor.

FIG. 9A illustrates a scatterplot of the sensitivity of the biosensor for each target analyte value to the hematocrit in the sample without the utilization of the technique shown in one of FIGS. 6 and 7.

FIG. 9B illustrates a scatterplot using the same parameters as in FIG. 9A but with our new technique to reduce the sensitivity of the biosensor to hematocrits as a function of temperature.

### MODES OF CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values ±10% of the recited value, e.g. “about 90%” may refer to the range of values from 81% to 99%. In addition, as used herein, the terms “patient,” “host,” “user,” and “subject” refer to any human or animal subject and are not intended to limit the systems or methods to human use, although use of the subject invention in a human patient represents a preferred embodiment. As used herein, “oscillating signal” includes voltage signal(s) or current signal(s) that, respectively, change polarity or alternate direction of current or are multi-directional. Also used herein, the phrase “electrical signal” or “signal” is intended to include direct current signal, alternating signal or any signal within the electromagnetic spectrum. The terms “processor”; “microprocessor”; or “microcontroller” are intended to have the same meaning and are intended to be used interchangeably.

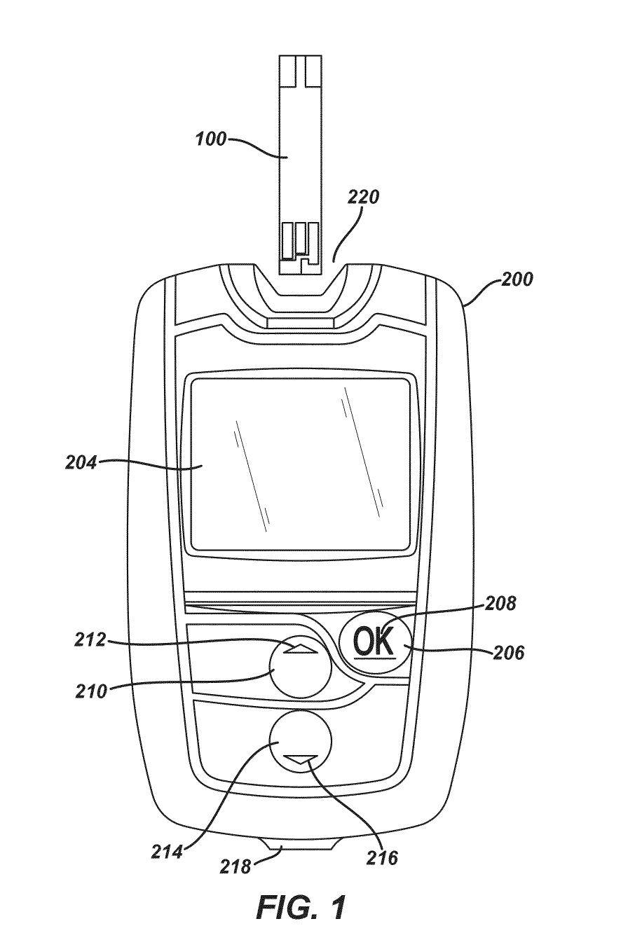

FIG. 1 illustrates a test meter 200, for testing analyte (e.g., glucose) levels in the blood of an individual with a test strip produced by the methods and techniques illustrated and described herein. Test meter 200 may include user interface inputs (206, 210, 214), which can be in the form of buttons, for entry of data, navigation of menus, and execution of commands. Data can include values representative of analyte concentration, and/or information that are related to the everyday lifestyle of an individual. Information, which is related to the everyday lifestyle, can include food intake, medication use, the occurrence of health check-ups, general health condition and exercise levels of an individual. Test meter 200 can also include a display 204 that can be used to report measured glucose levels, and to facilitate entry of lifestyle related information.

Test meter 200 may include a first user interface input 206, a second user interface input 210, and a third user interface input 214. User interface inputs 206, 210, and 214 facilitate entry and analysis of data stored in the testing device, enabling a user to navigate through the user interface displayed on display 204. User interface inputs 206, 210, and 214 include a first marking 208, a second marking 212, and a third marking 216, which help in correlating user interface inputs to characters on display 204.

Test meter 200 can be turned on by inserting a test strip 100 (or its variants 400, 500, or 600) into a strip port connector 220, by pressing and briefly holding first user interface input 206, or by the detection of data traffic across a data port 218. Test meter 200 can be switched off by removing test strip 100 (or its variants 400, 500, or 600), pressing and briefly holding first user interface input 206, navigating to and selecting a meter off option from a main menu screen, or by not pressing any buttons for a predetermined time. Display 104 can optionally include a backlight.

In one embodiment, test meter 200 can be configured to not receive a calibration input for example, from any external source, when switching from a first test strip batch to a second test strip batch. Thus, in one exemplary embodiment, the meter is configured to not receive a calibration input from external sources, such as a user interface (such as inputs 206, 210, 214), an inserted test strip, a separate code key or a code strip, data port 218. Such a calibration input is not necessary when all of the test strip batches have a substantially uniform calibration characteristic. The calibration input can be a set of values ascribed to a particular test strip batch. For example, the calibration input can include a batch slope and a batch intercept value for a particular test strip batch. The calibrations input, such as batch slope and intercept values, may be preset within the meter as will be described below.

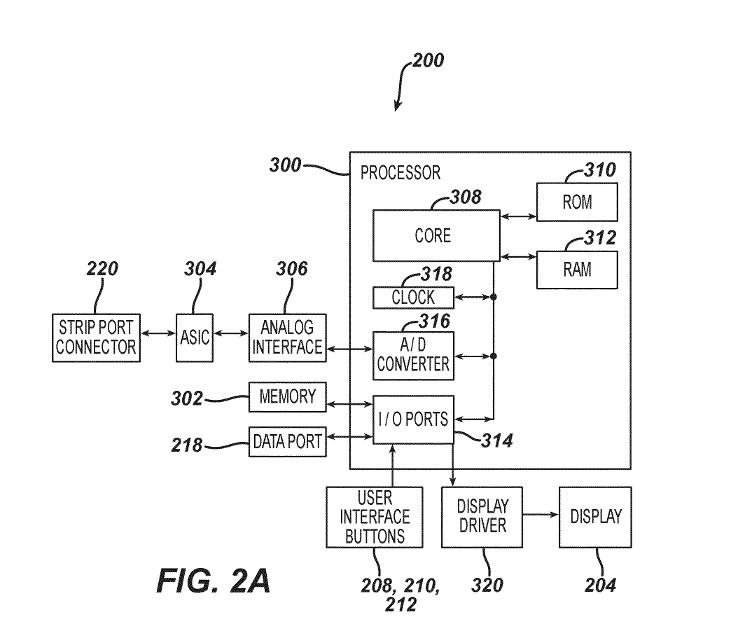

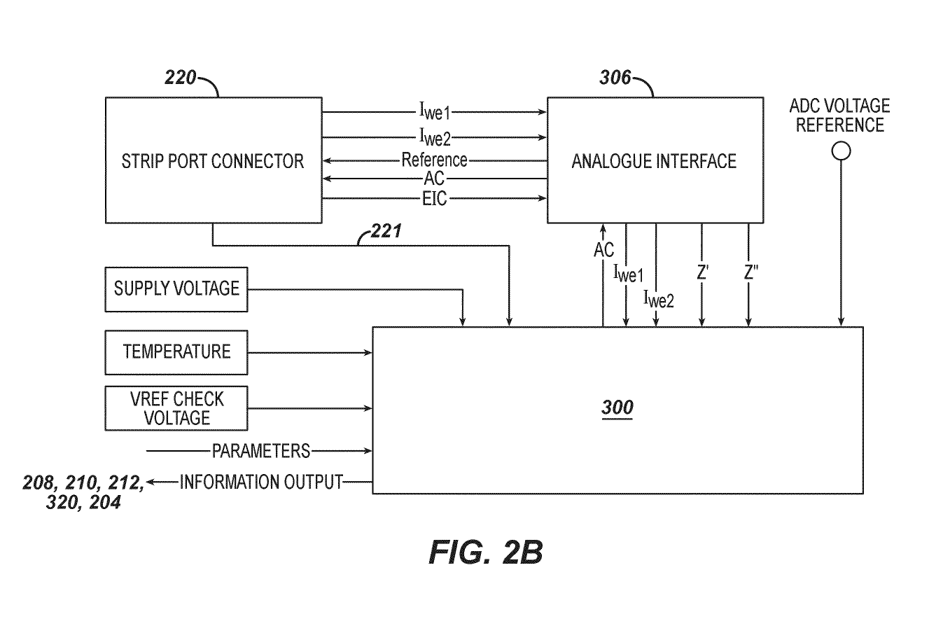

Referring to FIG. 2A, an exemplary internal layout of test meter 200 is shown. Test meter 200 may include a processor 300, which in some embodiments described and illustrated herein is a 32-bit RISC microcontroller. In the preferred embodiments described and illustrated herein, processor 300 is preferably selected from the MSP 430 family of ultra-low power microcontrollers manufactured by Texas Instruments of Dallas, Tex. The processor can be bi-directionally connected via I/O ports 314 to a memory 302, which in some embodiments described and illustrated herein is an EEPROM. Also connected to processor 300 via I/O ports 214 are the data port 218, the user interface inputs 206, 210, and 214, and a display driver 320. Data port 218 can be connected to processor 300, thereby enabling transfer of data between memory 302 and an external device, such as a personal computer. User interface inputs 206, 210, and 214 are directly connected to processor 300. Processor 300 controls display 204 via display driver 320. Memory 302 may be pre-loaded with calibration information, such as batch slope and batch intercept values, during production of test meter 200. This pre-loaded calibration information can be accessed and used by processor 300 upon receiving a suitable signal (such as current) from the strip via strip port connector 220 so as to calculate a corresponding analyte level (such as blood glucose concentration) using the signal and the calibration information without receiving calibration input from any external source.

In embodiments described and illustrated herein, test meter 200 may include an Application Specific Integrated Circuit (ASIC) 304, so as to provide electronic circuitry used in measurements of glucose level in blood that has been applied to a test strip 100 (or its variants 400, 500, or 600) inserted into strip port connector 220. Analog voltages can pass to and from ASIC 304 by way of an analog interface 306. Analog signals from analog interface 306 can be converted to digital signals by an A/D converter 316. Processor 300 further includes a core 308, a ROM 310 (containing computer code), a RAM 312, and a clock 318. In one embodiment, the processor 300 is configured (or programmed) to disable all of the user interface inputs except for a single input upon a display of an analyte value by the display unit such as, for example, during a time period after an analyte measurement. In an alternative embodiment, the processor 300 is configured (or programmed) to ignore any input from all of the user interface inputs except for a single input upon a display of an analyte value by the display unit. Detailed descriptions and illustrations of the meter 200 are shown and described in International Patent Application Publication No. WO2006070200, which is hereby incorporated by reference into this application as if fully set forth herein.

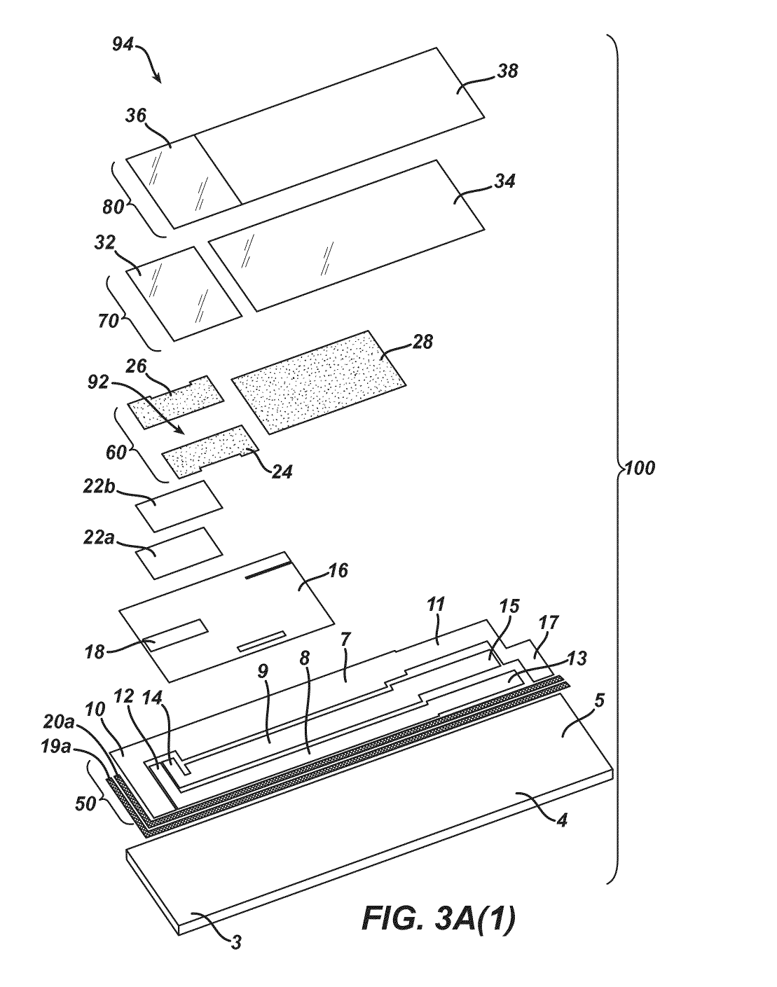

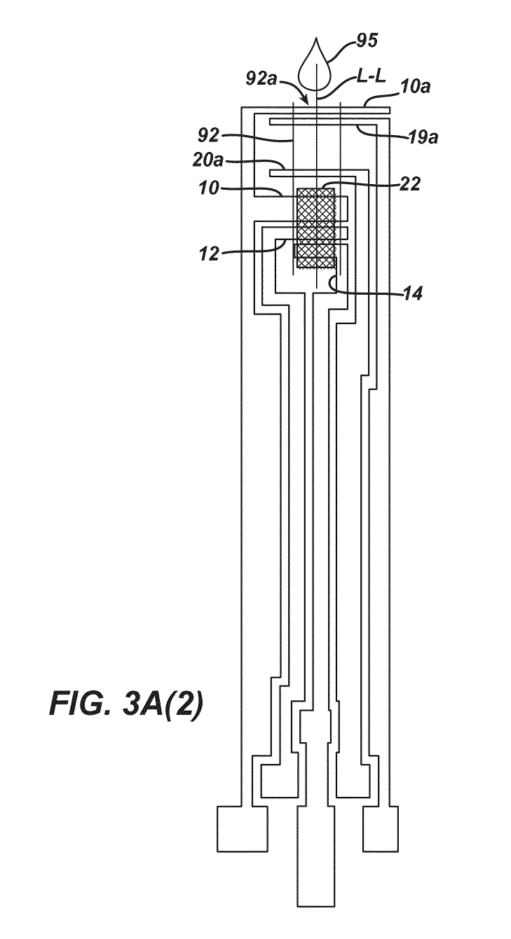

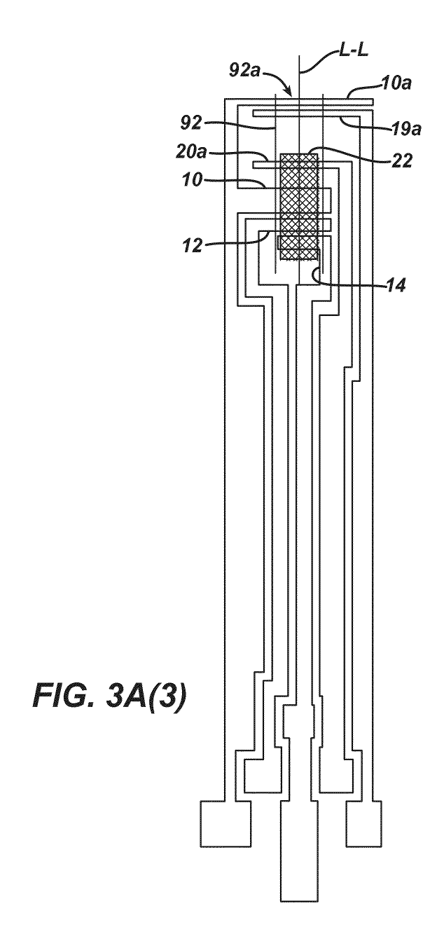

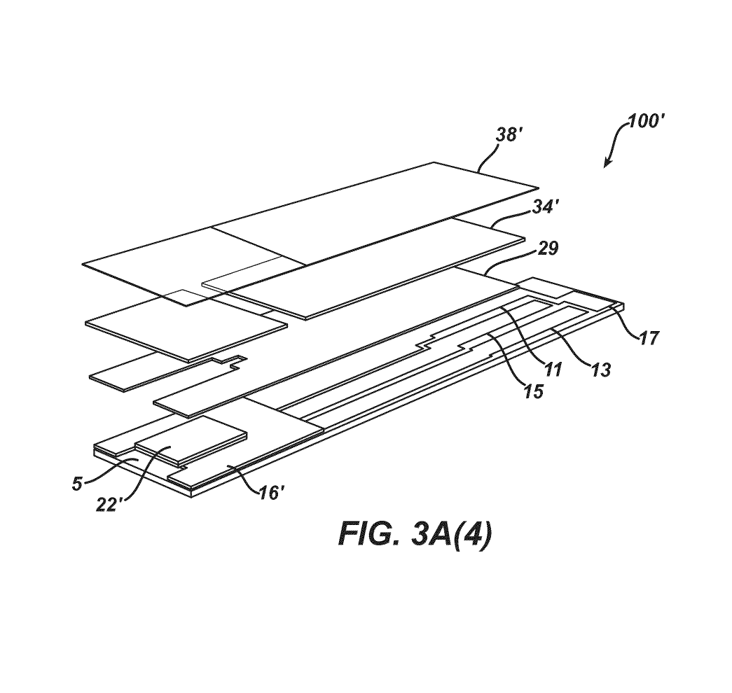

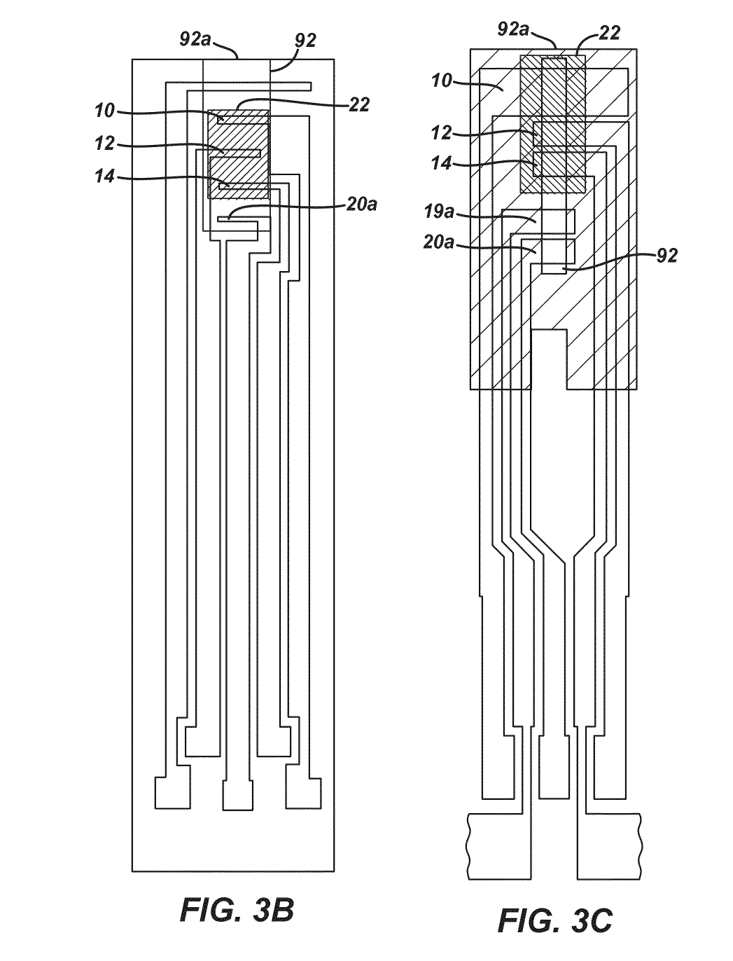

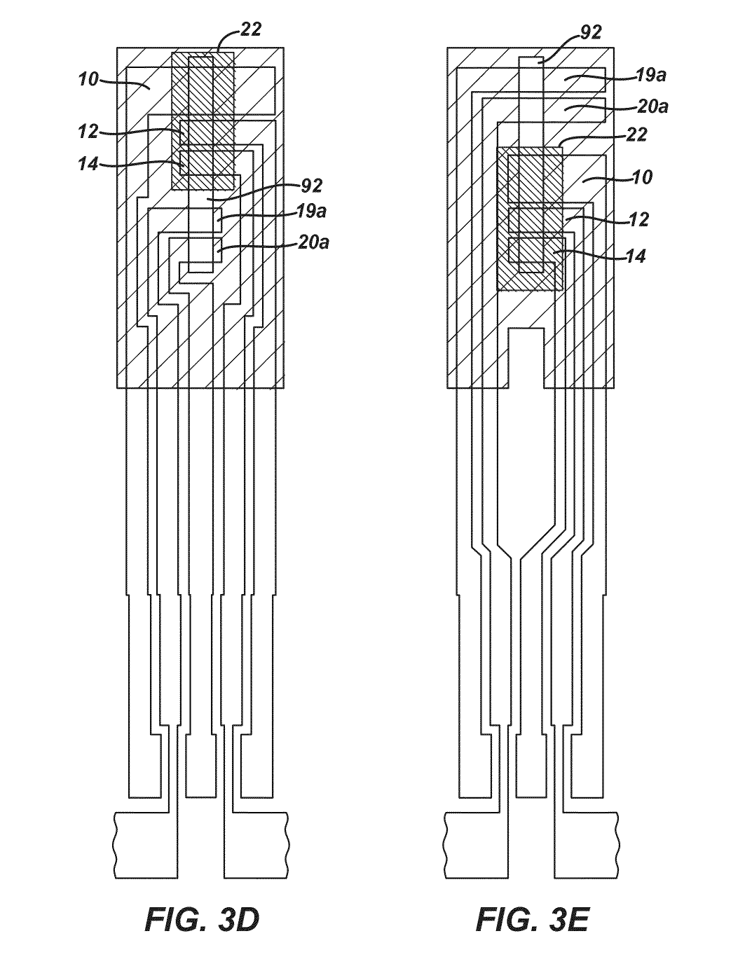

FIG. 3A(1) is an exemplary exploded perspective view of a test strip 100, which may include seven layers disposed on a substrate 5. The seven layers disposed on substrate 5 can be a first conductive layer 50 (which can also be referred to as electrode layer 50), an insulation layer 16, two overlapping reagent layers 22a and 22b, an adhesive layer 60 which includes adhesive portions 24, 26, and 28, a hydrophilic layer 70, and a top layer 80 which forms a cover 94 for the test strip 100. Test strip 100 may be manufactured in a series of steps where the conductive layer 50, insulation layer 16, reagent layers 22, and adhesive layer 60 are sequentially deposited on substrate 5 using, for example, a screen-printing process. Note that the electrodes 10, 12, and 14) are disposed for contact with the reagent layer 22a and 22b whereas the physical characteristic signal sensing electrodes 19a and 20a are spaced apart and not in contact with the reagent layer 22. Hydrophilic layer 70 and top layer 80 can be disposed from a roll stock and laminated onto substrate 5 as either an integrated laminate or as separate layers. Test strip 100 has a distal portion 3 and a proximal portion 4 as shown in FIG. 3A(1).

Test strip 100 may include a sample-receiving chamber 92 through which a physiological fluid sample 95 may be drawn through or deposited (FIG. 3A(2)). The physiological fluid sample discussed herein may be blood. Sample-receiving chamber 92 can include an inlet at a proximal end and an outlet at the side edges of test strip 100, as illustrated in FIG. 3A(1). A fluid sample 95 can be applied to the inlet along axis L-L (FIG. 3A(2)) to fill a sample-receiving chamber 92 so that glucose can be measured. The side edges of a first adhesive pad 24 and a second adhesive pad 26 located adjacent to reagent layer 22 each define a wall of sample-receiving chamber 92, as illustrated in FIG. 3A(1). A bottom portion or “floor” of sample-receiving chamber 92 may include a portion of substrate 5, conductive layer 50, and insulation layer 16, as illustrated in FIG. 3A(1). A top portion or “roof” of sample-receiving chamber 92 may include distal hydrophilic portion 32, as illustrated in FIG. 3A(1). For test strip 100, as illustrated in FIG. 3A(1), substrate 5 can be used as a foundation for helping support subsequently applied layers. Substrate 5 can be in the form of a polyester sheet such as a polyethylene tetraphthalate (PET) material (Hostaphan PET supplied by Mitsubishi). Substrate 5 can be in a roll format, nominally 350 microns thick by 370 millimeters wide and approximately 60 meters in length.

A conductive layer is required for forming electrodes that can be used for the electrochemical measurement of glucose. First conductive layer 50 can be made from a carbon ink that is screen-printed onto substrate 5. In a screen-printing process, carbon ink is loaded onto a screen and then transferred through the screen using a squeegee. The printed carbon ink can be dried using hot air at about 140° C. The carbon ink can include VAGH resin, carbon black, graphite (KS15), and one or more solvents for the resin, carbon and graphite mixture. More particularly, the carbon ink may incorporate a ratio of carbon black:VAGH resin of about 2.90:1 and a ratio of graphite:carbon black of about 2.62:1 in the carbon ink.

For test strip 100, as illustrated in FIG. 3A(1), first conductive layer 50 may include a reference electrode 10, a first working electrode 12, a second working electrode 14, third and fourth physical characteristic signal sensing electrodes 19a and 20a, a first contact pad 13, a second contact pad 15, a reference contact pad 11, a first working electrode track 8, a second working electrode track 9, a reference electrode track 7, and a strip detection bar 17. The physical characteristic signal sensing electrodes 19a and 20a are provided with respective electrode tracks 19b and 20b. The conductive layer may be formed from carbon ink. First contact pad 13, second contact pad 15, and reference contact pad 11 may be adapted to electrically connect to a test meter. First working electrode track 8 provides an electrically continuous pathway from first working electrode 12 to first contact pad 13. Similarly, second working electrode track 9 provides an electrically continuous pathway from second working electrode 14 to second contact pad 15. Similarly, reference electrode track 7 provides an electrically continuous pathway from reference electrode 10 to reference contact pad 11. Strip detection bar 17 is electrically connected to reference contact pad 11. Third and fourth electrode tracks 19b and 20b connect to the respective electrodes 19a and 20a. A test meter can detect that test strip 100 has been properly inserted by measuring a continuity between reference contact pad 11 and strip detection bar 17, as illustrated in FIG. 3A(1).

Variations of the test strip 100 (FIG. 3A(1), 3A(2), 3A(3), or 3A(4)) are shown in FIGS. 3B-3F. Briefly, with regard to variations of test strip 100 (illustrated exemplarily in FIGS. 3A(2), 3A(2) and 3B-3F), these test strips include an enzymatic reagent layer disposed on the working electrode, a patterned spacer layer disposed over the first patterned conductive layer and configured to define a sample chamber within the analytical test strip, and a second patterned conductive layer disposed above the first patterned conductive layer. The second patterned conductive layer includes a first phase-shift measurement electrode and a second phase-shift measurement electrode. Moreover, the first and second phase-shift measurement electrodes are disposed in the sample chamber and are configured to measure, along with the hand-held test meter, a phase shift of an electrical signal forced through a bodily fluid sample introduced into the sample chamber during use of the analytical test strip. Such phase-shift measurement electrodes are also referred to herein as bodily fluid phase-shift measurement electrodes. Analytical test strips of various embodiments described herein are believed to be advantageous in that, for example, the first and second phase-shift measurement electrodes are disposed above the working and reference electrodes, thus enabling a sample chamber of advantageously low volume. This is in contrast to a configuration wherein the first and second phase-shift measurement electrodes are disposed in a co-planar relationship with the working and reference electrodes thus requiring a larger bodily fluid sample volume and sample chamber to enable the bodily fluid sample to cover the first and second phase-shift measurement electrodes as well as the working and reference electrodes.

In the embodiment of FIG. 3A(2) which is a variation of the test strip of FIG. 3A(1), an additional electrode 10a is provided as an extension of any of the plurality of electrodes 19a, 20a, 14, 12, and 10. It must be noted that the built-in shielding or grounding electrode 10a is used to reduce or eliminate any capacitance coupling between the finger or body of the user and the characteristic measurement electrodes 19a and 20a. The grounding electrode 10a allows for any capacitance to be directed away from the sensing electrodes 19a and 20a. To do this, the grounding electrode 10a can be connected any one of the other five electrodes or to its own separate contact pad (and track) for connection to ground on the meter instead of one or more of contact pads 15, 17, 13 via respective tracks 7, 8, and 9. In a preferred embodiment, the grounding electrode 10a is connected to one of the three electrodes that has reagent 22 disposed thereon. In a most preferred embodiment, the grounding electrode 10a is connected to electrode 10. Being the grounding electrode, it is advantageous to connect the grounding electrode to the reference electrode (10) so not to contribute any additional current to the working electrode measurements which may come from background interfering compounds in the sample. Further by connecting the shield or grounding electrode 10a to electrode 10 this is believed to effectively increase the size of the counter electrode 10 which can become limiting especially at high signals. In the embodiment of FIG. 3A(2), the reagent are arranged so that they are not in contact with the measurement electrodes 19a and 20a. Alternatively, in the embodiment of FIG. 3A(3), the reagent 22 is arranged so that the reagent 22 contacts at least one of the sensing electrodes 19a and 20a.

In alternate version of test strip 100, shown here in FIG. 3A(4), the top layer 38, hydrophilic film layer 34 and spacer 29 have been combined together to form an integrated assembly for mounting to the substrate 5 with reagent layer 22′ disposed proximate insulation layer 16′.

In the embodiment of FIG. 3B, the analyte measurement electrodes 10, 12, and 14 are disposed in generally the same configuration as in FIG. 3A(1), 3A(2), or 3A(3). The electrodes 19a and 20a to sense physical characteristic signal (e.g., hematocrit) level, however, are disposed in a spaced apart configuration in which one electrode 19a is proximate an entrance 92a to the test chamber 92 and another electrode 20a is at the opposite end of the test chamber 92. Electrodes 10, 12, and 14 are disposed to be in contact with a reagent layer 22.

In FIGS. 3C, 3D, 3E and 3F, the physical characteristic signal (e.g., hematocrit) sensing electrodes 19a and 20a are disposed adjacent each other and may be placed at the opposite end 92b of the entrance 92a to the test chamber 92 (FIGS. 3C and 3D) or adjacent the entrance 92a (FIGS. 3E and 3F). In all of these embodiments, the physical characteristic signal sensing electrodes are spaced apart from the reagent layer 22 so that these physical characteristic signal sensing electrodes are not impacted by the electrochemical reaction of the reagent in the presence of a fluid sample (e.g., blood or interstitial fluid) containing glucose.

As is known, conventional electrochemical-based analyte test strips employ a working electrode along with an associated counter/reference electrode and enzymatic reagent layer to facilitate an electrochemical reaction with an analyte of interest and, thereby, determine the presence and/or concentration of that analyte. For example, an electrochemical-based analyte test strip for the determination of glucose concentration in a fluid sample can employ an enzymatic reagent that includes the enzyme glucose oxidase and the mediator ferricyanide (which is reduced to the mediator ferrocyanide during the electrochemical reaction). Such conventional analyte test strips and enzymatic reagent layers are described in, for example, U.S. Pat. Nos. 5,708,247; 5,951,836; 6,241,862; and 6,284,125; each of which is hereby incorporated by reference herein to this application. In this regard, the reagent layer employed in various embodiments provided herein can include any suitable sample-soluble enzymatic reagents, with the selection of enzymatic reagents being dependent on the analyte to be determined and the bodily fluid sample. For example, if glucose is to be determined in a fluid sample, enzymatic reagent layer 406 can include glucose oxidase or glucose dehydrogenase along with other components necessary for functional operation.

In general, enzymatic reagent layer 406 includes at least an enzyme and a mediator. Examples of suitable mediators include, for example, ruthenium, Hexaammine Ruthenium (III) Chloride, ferricyanide, ferrocene, ferrocene derivatives, osmium bipyridyl complexes, and quinone derivatives. Examples of suitable enzymes include glucose oxidase, glucose dehydrogenase (GDH) using a pyrroloquinoline quinone (PQQ) co-factor, GDH using a nicotinamide adenine dinucleotide (NAD) co-factor, and GDH using a flavin adenine dinucleotide (FAD) co-factor. Enzymatic reagent layer 406 can be applied during manufacturing using any suitable technique including, for example, screen printing.

Applicants note that enzymatic reagent layer 406 may also contain suitable buffers (such as, for example, Tris HCl, Citraconate, Citrate and Phosphate), hydroxyethylcelulose [HEC], carboxymethylcellulose, ethycellulose and alginate, enzyme stabilizers and other additives as are known in the field.

Further details regarding the use of electrodes and enzymatic reagent layers for the determination of the concentrations of analytes in a bodily fluid sample, albeit in the absence of the phase-shift measurement electrodes, analytical test strips and related methods described herein, are in U.S. Pat. No. 6,733,655, which is hereby fully incorporated by reference herein to this application.

Analytical test strips according to embodiments can be configured, for example, for operable electrical connection and use with the analytical test strip sample cell interface of a hand-held test meter as described in co-pending patent application Ser. No. 13/250,525 [tentatively identified by attorney docket number DDI5209USNP], which is hereby incorporated by reference herein to this application.

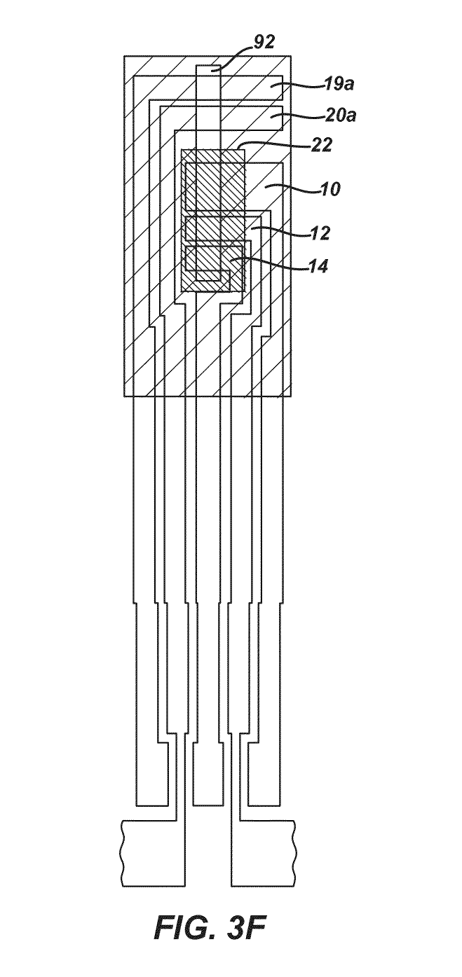

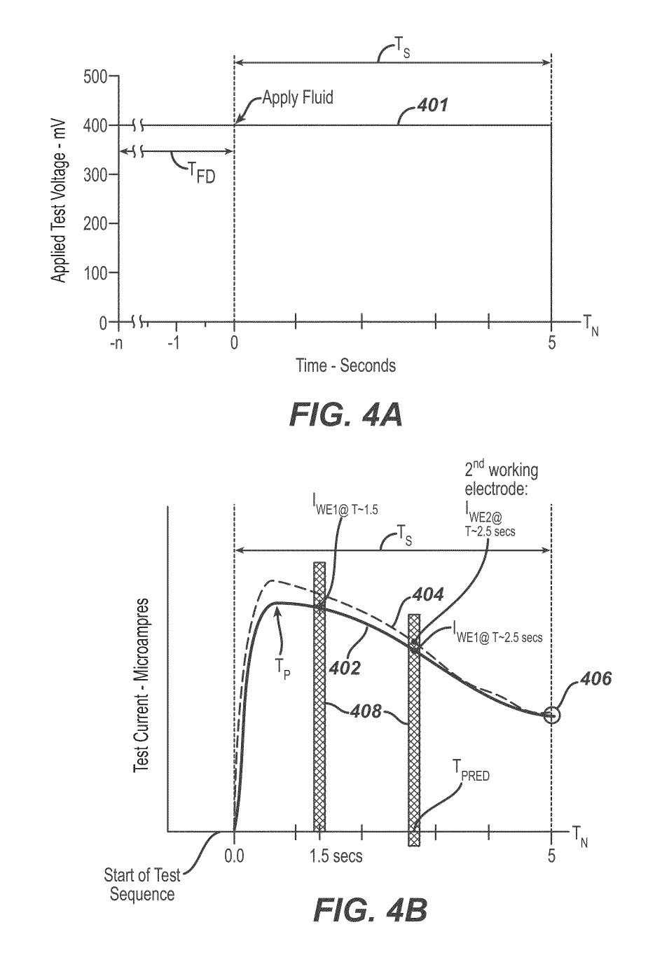

In the various embodiments of the test strip, there are two measurements that are made to a fluid sample deposited on the test strip. One measurement is that of the concentration of the analyte (e.g. glucose) in the fluid sample while the other is that of physical characteristic signal (e.g., hematocrit) in the same sample. Both measurements (glucose and hematocrit) can be performed in sequence, simultaneously or overlapping in duration. For example, the glucose measurement can be performed first then the physical characteristic signal (e.g., hematocrit); the physical characteristic signal (e.g., hematocrit) measurement first then the glucose measurement; both measurements at the same time; or a duration of one measurement may overlap a duration of the other measurement. Each measurement is discussed in detail as follow with respect to FIGS. 4A and 4B.

FIG. 4A is an exemplary chart of a test signal applied to test strip 100 and its variations shown here in FIGS. 3A-3F. Before a fluid sample is applied to test strip 100 (or its variants 400, 500, or 600), test meter 200 is in a fluid detection mode in which a first test signal of about 400 millivolts is applied between second working electrode and reference electrode. A second test signal of about 400 millivolts is preferably applied simultaneously between first working electrode (e.g., electrode 12 of strip 100) and reference electrode (e.g., electrode 10 of strip 100). Alternatively, the second test signal may also be applied contemporaneously such that a time interval of the application of the first test signal overlaps with a time interval in the application of the second test voltage. The test meter may be in a fluid detection mode during fluid detection time interval T_{FD} prior to the detection of physiological fluid at starting time at zero. In the fluid detection mode, test meter 200 determines when a fluid is applied to test strip 100 (or its variants 400, 500, or 600) such that the fluid wets either the first working electrode 12 or second working electrode 14 (or both working electrodes) with respect to reference electrode 10. Once test meter 200 recognizes that the physiological fluid has been applied because of, for example, a sufficient increase in the measured test current at either or both of first working electrode 12 and second working electrode 14, test meter 200 assigns a zero second marker at zero time “0” and starts the test time interval T_{S}. Test meter 200 may sample the current transient output at a suitable sampling rate, such as, for example, every 1 milliseconds to every 100 milliseconds. Upon the completion of the test time interval T_{S}, the test signal is removed. For simplicity, FIG. 4A only shows the first test signal applied to test strip 100 (or its variants 400, 500, or 600).

Hereafter, a description of how glucose concentration is determined from the known signal transients (e.g., the measured electrical signal response in nanoamperes as a function of time) that are measured when the test voltages of FIG. 4A are applied to the test strip 100 (or its variants 400, 500, or 600).

In FIG. 4A, the first and second test voltages applied to test strip 100 (or its variants described herein) are generally from about +100 millivolts to about +600 millivolts. In one embodiment in which the electrodes include carbon ink and the mediator includes ferricyanide, the test signal is about +400 millivolts. Other mediator and electrode material combinations will require different test voltages, as is known to those skilled in the art. The duration of the test voltages is generally from about 1 to about 5 seconds after a reaction period and is typically about 3 seconds after a reaction period. Typically, test sequence time T_{S} is measured relative to time T₀. As the voltage 401 is maintained in FIG. 4A for the duration of T_{S}, output signals are generated, shown here in FIG. 4B with the current transient 702 for the first working electrode 12 being generated starting at zero time and likewise the current transient 704 for the second working electrode 14 is also generated with respect to the zero time. It is noted that while the signal transients 702 and 704 have been placed on the same referential zero point for purposes of explaining the process, in physical term, there is a slight time differential between the two signals due to fluid flow in the chamber towards each of the working electrodes 12 and 14 along axis L-L. However, the current transients are sampled and configured in the microcontroller to have the same start time. In FIG. 4B, the current transients build up to a peak proximate peak time T_{P} at which time, the current slowly drops off until approximately one of 2.5 seconds or 5 seconds after zero time. At the point 706, approximately at 5 seconds, the output signal for each of the working electrodes 12 and 14 may be measured and added together. Alternatively, the signal from only one of the working electrodes 12 and 14 can be doubled.

Referring back to FIG. 2B, the system drives a signal to measure or sample the output signals I_{E} from at least one the working electrodes (12 and 14) at any one of a plurality of time points or positions T₁, T₂, T₃, . . . . T_{N}. As can be seen in FIG. 4B, the time position can be any time point or interval in the test sequence T_{S}. For example, the time position at which the output signal is measured can be a single time point T_{1.5} at 1.5 seconds or an interval 708 (e.g., interval˜10 milliseconds or more depending on the sampling rate of the system) overlapping the time point T_{2.8} proximate 2.8 seconds.

From knowledge of the parameters of the test strip (e.g., batch calibration code offset and batch slope) for the particular test strip 100 and its variations, the analyte (e.g., glucose) concentration can be calculated. Output transient 702 and 704 can be sampled to derive signals I_{E} (by summation of each of the current I_{WE1} and I_{WE2} or doubling of one of I_{WE1} or I_{WE2}) at various time intervals during the test sequence. From knowledge of the batch calibration code offset and batch slope for the particular test strip 100 and its variations in FIGS. 3B-3F, the analyte (e.g., glucose) concentration can be calculated.

It is noted that “Intercept” and “Slope” are the values obtained by measuring calibration data from a batch of test strips. Typically around 1500 strips are selected at random from the lot or batch. Physiological fluid (e.g., blood) from donors is spiked to various analyte levels, typically six different glucose concentrations. Typically, blood from 12 different donors is spiked to each of the six levels. Eight strips are given blood from identical donors and levels so that a total of 12×6×8=576 tests are conducted for that lot. These are benchmarked against actual analyte level (e.g., blood glucose concentration) by measuring these using a standard laboratory analyzer such as Yellow Springs Instrument (YSI). A graph of measured glucose concentration is plotted against actual glucose concentration (or measured current versus YSI current) and a formula y=mx+c least squares fitted to the graph to give a value for batch slope m and batch intercept c for the remaining strips from the lot or batch. The applicants have also provided methods and systems in which the batch slope is derived during the determination of an analyte concentration. The “batch slope”, or “Slope”, may therefore be defined as the measured or derived gradient of the line of best fit for a graph of measured glucose concentration plotted against actual glucose concentration (or measured current versus YSI current). The “batch intercept”, or “Intercept”, may therefore be defined as the point at which the line of best fit for a graph of measured glucose concentration plotted against actual glucose concentration (or measured current versus YSI current) meets the y axis.

It is worthwhile here to note that the various components, systems and procedures described earlier allow for applicants to provide an analyte measurement system that heretofore was not available in the art. In particular, this system includes a test strip that has a substrate and a plurality of electrodes connected to respective electrode connectors. The system further includes an analyte meter 200 that has a housing, a test strip port connector configured to connect to the respective electrode connectors of the test strip, and a microcontroller 300, shown here in FIG. 2B. The microprocessor 300 is in electrical communication with the test strip port connector 220 to apply electrical signals or sense electrical signals from the plurality of electrodes.

Referring to FIG. 2B, details of a preferred implementation of meter 200 where the same numerals in FIGS. 2A and 2B have a common description. In FIG. 2B, a strip port connector 220 is connected to the analogue interface 306 by five lines including an impedance sensing line EIC to receive signals from physical characteristic signal sensing electrode(s), alternating signal line AC driving signals to the physical characteristic signal sensing electrode(s), reference line for a reference electrode, and signal sensing lines from respective working electrode 1 and working electrode 2. A strip detection line 221 can also be provided for the connector 220 to indicate insertion of a test strip. The analog interface 306 provides four inputs to the processor 300: (1) real impedance Z′; (2) imaginary impedance Z″; (3) signal sampled or measured from working electrode 1 of the biosensor or I_{we1}; (4) signal sampled or measured from working electrode 2 of the biosensor or I_{we2}. There is one output from the processor 300 to the interface 306 to drive an oscillating signal AC of any value from 25 kHz to about 250 kHz or higher to the physical characteristic signal sensing electrodes. A phase differential P (in degrees) can be determined from the real impedance Z′ and imaginary impedance Z″ where:

P=tan⁻¹{Z″/Z′} Eq. 3.1

and magnitude M (in ohms and conventionally written as |Z|) from line Z′ and Z″ of the interface 306 can be determined where

M=\sqrt{(Z′)²+(Z″)²} Eq. 3.2

In this system, the microprocessor is configured to: (a) apply a first signal to the plurality of electrodes so that a batch slope defined by a physical characteristic signal of a fluid sample is derived and (b) apply a second signal to the plurality of electrodes so that an analyte concentration is determined based on the derived batch slope. For this system, the plurality of electrodes of the test strip or biosensor includes at least two electrodes to measure the physical characteristic signal and at least two other electrodes to measure the analyte concentration. For example, the at least two electrodes and the at least two other electrodes are disposed in the same chamber provided on the substrate. Alternatively, the at least two electrodes and the at least two other electrodes are disposed in different chambers provided on the substrate. It is noted that for some embodiments, all of the electrodes are disposed on the same plane defined by the substrate. In particular, in some of the embodiments described herein, a reagent is disposed proximate the at least two other electrodes and no reagent is disposed on the at least two electrodes. One feature of note in this system is the ability to provide for an accurate analyte measurement within about 10 seconds of deposition of a fluid sample (which may be a physiological sample) onto the biosensor as part of the test sequence.

As an example of an analyte calculation (e.g., glucose) for strip 100 (FIG. 3A(1), 3A(2), or 3A(3) and its variants in FIGS. 3B-3F), it is assumed in FIG. 4B that the sampled signal value at 706 for the first working electrode 12 is about 1600 nanoamperes whereas the signal value at 706 for the second working electrode 14 is about 1300 nanoamperes and the calibration code of the test strip indicates that the Intercept is about 500 nanoamperes and the Slope is about 18 nanoamperes/mg/dL. Glucose concentration G₀ can be thereafter be determined from Equation 3.3 as follow:

G₀=[(I_{E})−Intercept]/Slope Eq. 3.3

where

I_{E} is a signal (proportional to analyte concentration) which is the total signal from all of the electrodes in the biosensor (e.g., for sensor 100, both electrodes 12 and 14 (or I_{we1}+I_{we2}));

I_{we1} is the signal measured for the first working electrode at the set analyte measurement sampling time;

I_{we2} is the signal measured for the second working electrode at the set analyte measurement sampling time;

Slope is the value obtained from calibration testing of a batch of test strips of which this particular strip comes from;

Intercept is the value obtained from calibration testing of a batch of test strips of which this particular strip comes from.

From Eq. 3.3; G₀=[(1600+1300)−500]/18 and therefore, G₀=133.33 nanoamp˜133 mg/dL.

It is noted here that although the examples have been given in relation to a biosensor 100 which has two working electrodes (12 and 14 in FIG. 3A(1)) such that the measured currents from respective working electrodes have been added together to provide for a total measured current I_{E}, the signal resulting from only one of the two working electrodes can be multiplied by two in a variation of test strip 100 where there is only one working electrode (either electrode 12 or 14). Instead of a total signal, an average of the signal from each working electrode can be used as the total measured current I_{E} for Equations 3.3, 6, and 8-11 described herein, and of course, with appropriate modification to the operational coefficients (as known to those skilled in the art) to account for a lower total measured current I_{E} than as compared to an embodiment where the measured signals are added together. Alternatively, the average of the measured signals can be multiplied by two and used as I_{E} in Equations 3.3, 6, and 8-11 without the necessity of deriving the operational coefficients as in the prior example. It is noted that the analyte (e.g., glucose) concentration here is not corrected for any physical characteristic signal (e.g., hematocrit value) and that certain offsets may be provided to the signal values I_{we1} and I_{we2} to account for errors or delay time in the electrical circuit of the meter 200. Temperature compensation can also be utilized to ensure that the results are calibrated to a referential temperature such as for example room temperature of about 20 degrees Celsius.

Now that a glucose concentration (G₀) can be determined from the signal I_{E}, a description of applicant's technique to determine the physical characteristic signal (e.g., hematocrit) of the fluid sample is provided. In system 200 (FIG. 2), the microcontroller applies a first oscillating input signal 800 at a first frequency (e.g., of about 25 kilo-Hertz) to a pair of sensing electrodes. The system is also set up to measure or detect a first oscillating output signal 802 from the third and fourth electrodes, which in particular involve measuring a first time differential Δt₁ between the first input and output oscillating signals. At the same time or during overlapping time durations, the system may also apply a second oscillating input signal (not shown for brevity) at a second frequency (e.g., about 100 kilo-Hertz to about 1 MegaHertz or higher, and preferably about 250 kilo Hertz) to a pair of electrodes and then measure or detect a second oscillating output signal from the third and fourth electrodes, which may involve measuring a second time differential Δt₂ (not shown) between the first input and output oscillating signals. From these signals, the system estimates a physical characteristic signal (e.g., hematocrit) of the fluid sample based on the first and second time differentials Δt₁ and Δt₂. Thereafter, the system is able to derive a glucose concentration. The estimate of the physical characteristic signal (e.g., hematocrit) can be done by applying an equation of the form

$${HCT}_{EST} = \frac{( {C}_{1} Δ {t}_{1} - {C}_{2} Δ {t}_{2} - {C}_{3} )}{{m}_{1}} \qquad Eq . 4.1$$

where
each of C₁, C₂, and C₃ is an operational constant for the test strip and
   m₁ represent a parameter from regressions data.

Details of this exemplary technique can be found in Provisional U.S. Patent Application Ser. No. 61/530,795 filed on Sep. 2, 2011, entitled, “Hematocrit Corrected Glucose Measurements for Electrochemical Test Strip Using Time Differential of the Signals” with Attorney Docket No. DDI-5124USPSP, which is hereby incorporated by reference.

Another technique to determine physical characteristic signal (e.g., hematocrit) can be by two independent measurements of physical characteristic signal (e.g., hematocrit). This can be obtained by determining: (a) the impedance of the fluid sample at a first frequency and (b) the phase angle of the fluid sample at a second frequency substantially higher than the first frequency. In this technique, the fluid sample is modeled as a circuit having unknown reactance and unknown resistance. With this model, an impedance (as signified by notation “|Z|”) for measurement (a) can be determined from the applied voltage, the voltage across a known resistor (e.g., the intrinsic strip resistance), and the voltage across the unknown impedance Vz; and similarly, for measurement (b) the phase angle can be measured from a time difference between the input and output signals by those skilled in the art. Details of this technique is shown and described in pending provisional patent application Ser. No. 61/530,808 filed Sep. 2, 2011 (Attorney Docket No. DDI5215PSP), which is incorporated by reference. Other suitable techniques for determining the physical characteristic signal (e.g., hematocrit, viscosity, temperature or density) of the fluid sample can also be utilized such as, for example, U.S. Pat. No. 4,919,770, U.S. Pat. No. 7,972,861, US Patent Application Publication Nos. 2010/0206749, 2009/0223834, or “Electric Cell-Substrate Impedance Sensing (ECIS) as a Noninvasive Means to Monitor the Kinetics of Cell Spreading to Artificial Surfaces” by Joachim Wegener, Charles R. Keese, and Ivar Giaever and published by Experimental Cell Research 259, 158-166 (2000) doi:10.1006/excr.2000.4919, available online at http://www.idealibrary.coml; “Utilization of AC Impedance Measurements for Electrochemical Glucose Sensing Using Glucose Oxidase to Improve Detection Selectivity” by Takuya Kohma, Hidefumi Hasegawa, Daisuke Oyamatsu, and Susumu Kuwabata and published by Bull. Chem. Soc. Jpn. Vol. 80, No. 1, 158-165 (2007), all of these documents are incorporated by reference.

Another technique to determine the physical characteristic signal (e.g., hematorcrits, density, or temperature) can be obtained by knowing the phase difference (e.g., phase angle) and magnitude of the impedance of the sample. In one example, the following relationship is provided for the estimate of the physical characteristic signal or impedance characteristic of the sample (“IC”), defined here in Equation 4.2:

IC=M²*y₁+M*y₂+y₃+P²*y₄+P*y₅ Eq. 4.2
where: M represents a magnitude |Z| of a measured impedance in ohms);
P represents a phase difference between the input and output signals (in degrees)
y₁ is about −3.2e−08 and ±10%, 5% or 1% of the numerical value provided hereof (and depending on the frequency of the input signal, can be zero);
y₂ is about 4.1e−03 and ±10%, 5% or 1% of the numerical value provided hereof (and depending on the frequency of the input signal, can be zero);
y₃ is about −2.5e+01 and ±10%, 5% or 1% of the numerical value provided hereof;
y₄ is about 1.5e−01 and ±10%, 5% or 1% of the numerical value provided hereof (and depending on the frequency of the input signal, can be zero); and
y₅ is about 5.0 and ±10%, 5% or 1% of the numerical value provided hereof (and depending on the frequency of the input signal, can be zero).

It is noted here that where the frequency of the input AC signal is high (e.g., greater than 75 kHz) then the parametric terms y₁ and y₂ relating to the magnitude of impedance M may be ±200% of the exemplary values given herein such that each of the parametric terms may include zero or even a negative value. On the other hand, where the frequency of the AC signal is low (e.g., less than 75 kHz), the parametric terms y₄ and y₅ relating to the phase angle P may be ±200% of the exemplary values given herein such that each of the parametric terms may include zero or even a negative value. It is noted here that a magnitude of H or HCT, as used herein, is generally equal to the magnitude of IC. In one exemplary implementation, H or HCT is equal to IC as H or HCT is used herein this application.

In another alternative implementation, Equation 4.3 is provided. Equation 4.3 is the exact derivation of the quadratic relationship, without using phase angles as in Equation 4.2.

$$IC = \frac{- {y}_{2} + \vert \sqrt{{y}_{2}^{2} - ( 4 {y}_{3} ( {y}_{1} - M ) )} \vert}{2 {y}_{1}} \qquad Eq . 4.3$$

where:
IC is the Impedance Characteristic [%];
M is the magnitude of impedance [Ohm];
y₁ is about 1.2292e1 and ±10%, 5% or 1% of the numerical value provided hereof;
y₂ is about −4.3431e2 and ±10%, 5% or 1% of the numerical value provided hereof;
y₃ is about 3.5260e4 and ±10%, 5% or 1% of the numerical value provided hereof.

By virtue of the various components, systems and insights provided herein, at least four techniques of determining an analyte concentration from a fluid sample (which may be a physiological sample) (and variations of such method) are achieved by applicants. These techniques are shown and described in extensive details in commonly-owned prior U.S. patent application Ser. No. 14/353,870 filed on Apr. 24, 2014 (Attorney Docket No. DDI5220USPCT, which claims the benefits of priority to Dec. 29, 2011); Ser. No. 14/354,377 filed on Apr. 24, 2014 (Attorney Docket No. DDI5228USPCT with the benefits of priority back to Dec. 29, 2011); and Ser. No. 14/354,387 filed on Apr. 25, 2014 (Attorney Docket No. DDI5246USPCT with the benefits of priority claimed back to May 31, 2012), all of the prior applications (hereafter designated as “Earlier Applications”) are hereby incorporated by reference as if set forth herein.

As described extensively in our Earlier Applications, a measured or estimated physical characteristic IC is used in Table 1 along with an estimated analyte concentration G_{E} to derive a measurement time T at which the sample is to be measured, as referenced to a suitable datum, such as the start of the test assay sequence. For example, if the measured charactertistic is about 30% and the estimated glucose (e.g., by sampling at about 2.5 to 3 seconds) is about 350, the time at which the microcontroller should sample the fluid is about 7 seconds (as referenced to a test sequence start datum) in Table 1. In another example, where the estimated glucose is about 300 mg/dL and the measured or estimated physical characteristic is 60%, specified sampling time would be about 3.1 seconds, shown in Table 1.

TABLE 1
Sampling Time T to Estimated G and Measured or Estimated Physical
Characteristic

| Estimated | Measured or Estimated | | | | | | | | | | | | |
|---|---|---|---|---|---|---|---|---|---|---|---|---|---|
| G | Physical Characteristic (e.g., HCT [%]) | | | | | | | | | | | | |
| [mg/dL] | 24 | 27 | 30 | 33 | 36 | 39 | 42 | 45 | 48 | 51 | 54 | 57 | 60 |
| 25 | 4.6 | 4.6 | 4.5 | 4.4 | 4.4 | 4.4 | 4.3 | 4.3 | 4.3 | 4.2 | 4.1 | 4.1 | 4.1 |
| 50 | 5 | 4.9 | 4.8 | 4.7 | 4.7 | 4.6 | 4.5 | 4.4 | 4.3 | 4.2 | 4.1 | 4 | 4 |
| 75 | 5.3 | 5.3 | 5.2 | 5 | 4.9 | 4.8 | 4.7 | 4.5 | 4.4 | 4.3 | 4.1 | 4 | 3.8 |
| 100 | 5.8 | 5.6 | 5.4 | 5.3 | 5.1 | 5 | 4.8 | 4.6 | 4.4 | 4.3 | 4.1 | 3.9 | 3.7 |
| 125 | 6.1 | 5.9 | 5.7 | 5.5 | 5.3 | 5.1 | 4.9 | 4.7 | 4.5 | 4.3 | 4.1 | 3.8 | 3.6 |
| 150 | 6.4 | 6.2 | 5.9 | 5.7 | 5.5 | 5.3 | 5 | 4.8 | 4.6 | 4.3 | 4 | 3.8 | 3.5 |
| 175 | 6.6 | 6.4 | 6.2 | 5.9 | 5.6 | 5.4 | 5.2 | 4.9 | 4.6 | 4.3 | 4 | 3.7 | 3.4 |
| 200 | 6.8 | 6.6 | 6.4 | 6.1 | 5.8 | 5.5 | 5.2 | 4.9 | 4.6 | 4.3 | 4 | 3.7 | 3.4 |
| 225 | 7.1 | 6.8 | 6.5 | 6.2 | 5.9 | 5.6 | 5.3 | 5 | 4.7 | 4.3 | 4 | 3.6 | 3.2 |
| 250 | 7.3 | 7 | 6.7 | 6.4 | 6 | 5.7 | 5.3 | 5 | 4.7 | 4.3 | 4 | 3.6 | 3.2 |
| 275 | 7.4 | 7.1 | 6.8 | 6.4 | 6.1 | 5.8 | 5.4 | 5 | 4.7 | 4.3 | 4 | 3.5 | 3.2 |
| 300 | 7.5 | 7.1 | 6.8 | 6.5 | 6.2 | 5.8 | 5.5 | 5.1 | 4.7 | 4.3 | 4 | 3.5 | 3.1 |
| w325 | 7.6 | 7.3 | 6.9 | 6.5 | 6.2 | 5.8 | 5.5 | 5.1 | 4.7 | 4.3 | 3.9 | 3.5 | 3.1 |
| 350 | 7.6 | 7.3 | 7 | 6.6 | 6.2 | 5.8 | 5.5 | 5.1 | 4.7 | 4.3 | 3.9 | 3.5 | 3.1 |
| 375 | 7.7 | 7.3 | 7 | 6.6 | 6.2 | 5.8 | 5.5 | 5.1 | 4.7 | 4.3 | 3.9 | 3.5 | 3.1 |
| 400 | 7.7 | 7.3 | 6.9 | 6.5 | 6.2 | 5.8 | 5.4 | 5 | 4.7 | 4.3 | 3.9 | 3.5 | 3.1 |
| 425 | 7.6 | 7.3 | 6.9 | 6.5 | 6.2 | 5.8 | 5.4 | 5 | 4.6 | 4.3 | 3.8 | 3.5 | 3.1 |
| 450 | 7.6 | 7.2 | 6.8 | 6.4 | 6.1 | 5.7 | 5.3 | 5 | 4.6 | 4.3 | 3.8 | 3.5 | 3.1 |
| 475 | 7.4 | 7.1 | 6.7 | 6.4 | 6 | 5.6 | 5.3 | 4.9 | 4.6 | 4.2 | 3.8 | 3.5 | 3.1 |
| 500 | 7.3 | 7 | 6.6 | 6.2 | 5.9 | 5.5 | 5.2 | 4.9 | 4.5 | 4.1 | 3.8 | 3.5 | 3.2 |
| 525 | 7.1 | 6.8 | 6.5 | 6.1 | 5.8 | 5.5 | 5.1 | 4.8 | 4.4 | 4.1 | 3.8 | 3.5 | 3.2 |
| 550 | 7 | 6.7 | 6.3 | 5.9 | 5.6 | 5.3 | 5 | 4.7 | 4.4 | 4.1 | 3.8 | 3.5 | 3.2 |
| 575 | 6.8 | 6.4 | 6.1 | 5.8 | 5.5 | 5.2 | 4.9 | 4.6 | 4.3 | 4.1 | 3.8 | 3.5 | 3.4 |
| 600 | 6.5 | 6.2 | 5.9 | 5.6 | 5.3 | 5 | 4.7 | 4.5 | 4.3 | 4 | 3.8 | 3.6 | 3.4 |

Applicants note that the appropriate analyte measurement sampling time is measured from the start of the test sequence but any appropriate datum may be utilized in order to determine when to sample the output signal. As a practical matter, the system can be programmed to sample the output signal at an appropriate time sampling interval during the entire test sequence such as for example, one sampling every 100 milliseconds or even as little as about 1 milliseconds. By sampling the entire signal output transient during the test sequence, the system can perform all of the needed calculations near the end of the test sequence rather than attempting to synchronize the analyte measurement sampling time with the set time point, which may introduce timing errors due to system delay. Details of this technique are shown and described in the Earlier Applications.

Once the signal output I_{T} of the test chamber is measured at the designated time (which is governed by the measured or estimated physical characteristic), the signal I_{T} is thereafter used in the calculation of the analyte concentration (in this case glucose) with Equation 9 below.

$${G}_{0} = [ \frac{{I}_{T} - Intercept}{Slope} ] \qquad Eq . 5$$

where
G₀ represents an analyte concentration;
I_{T} represents a signal (proportional to analyte concentration) determined from the sum of the end signals measured at a specified analyte measurement sampling time T, which may be the total current measured at the specified analyte measurement sampling time T;
Slope represents the value obtained from calibration testing of a batch of test strips of which this particular strip comes from and is typically about 0.02; and
Intercept represents the value obtained from calibration testing of a batch of test strips of which this particular strip comes from and is typically from about 0.6 to about 0.7.

It should be noted that the step of applying the first signal and the driving of the second signal is sequential in that the order may be the first signal then the second signal or both signals overlapping in sequence; alternatively, the second signal first then the first signal or both signals overlapping in sequence. Alternatively, the applying of the first signal and the driving of the second signal may take place simultaneously.

In the method, the step of applying of the first signal involves directing an alternating signal provided by an appropriate power source (e.g., the meter 200) to the sample so that a physical characteristic signal representative of the sample is determined from an output of the alternating signal. The physical characteristic signal being detected may be one or more of viscosity, hematocrit or density. The directing step may include driving first and second alternating signal at different respective frequencies in which a first frequency is lower than the second frequency. Preferably, the first frequency is at least one order of magnitude lower than the second frequency. As an example, the first frequency may be any frequency in the range of about 10 kHz to about 100 kHz and the second frequency may be from about 250 kHz to about 1 MHz or more. As used herein, the phrase “alternating signal” or “oscillating signal” can have some portions of the signal alternating in polarity or all alternating current signal or an alternating current with a direct current offset or even a multi-directional signal combined with a direct-current signal.

Further refinements are shown and described with respect to Table 2 of International Patent Application No. PCT/GB2012/053276, filed on Dec. 28, 2012 and published as WO2013/098563 and therefore are not repeated here.

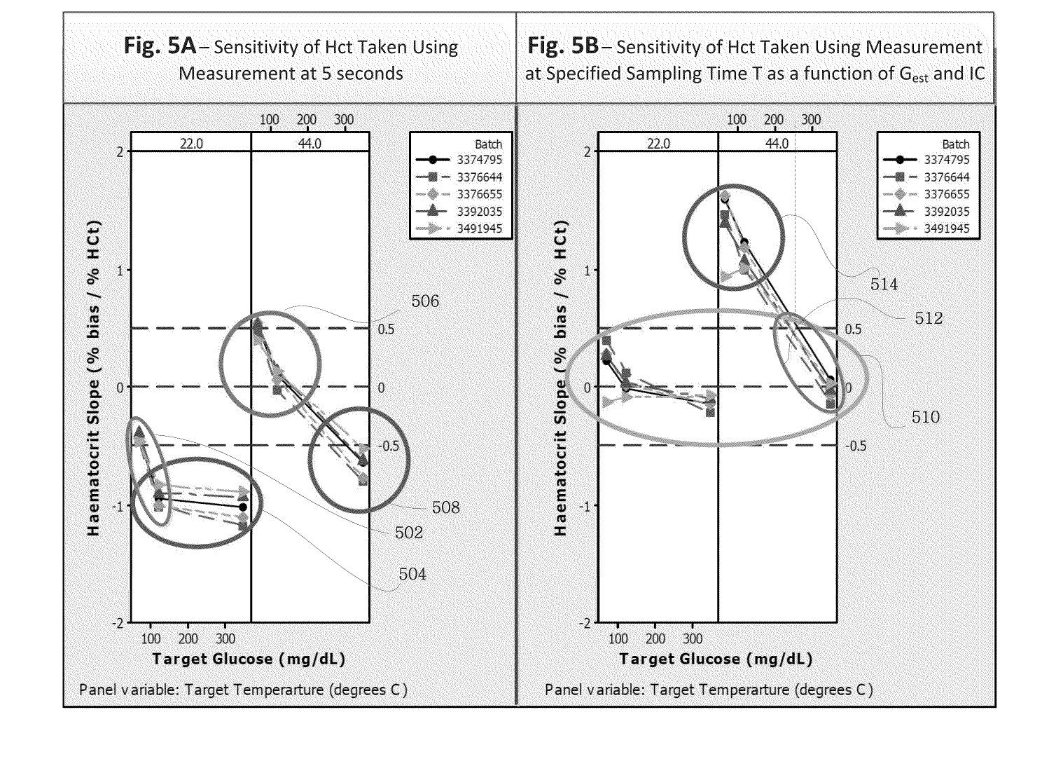

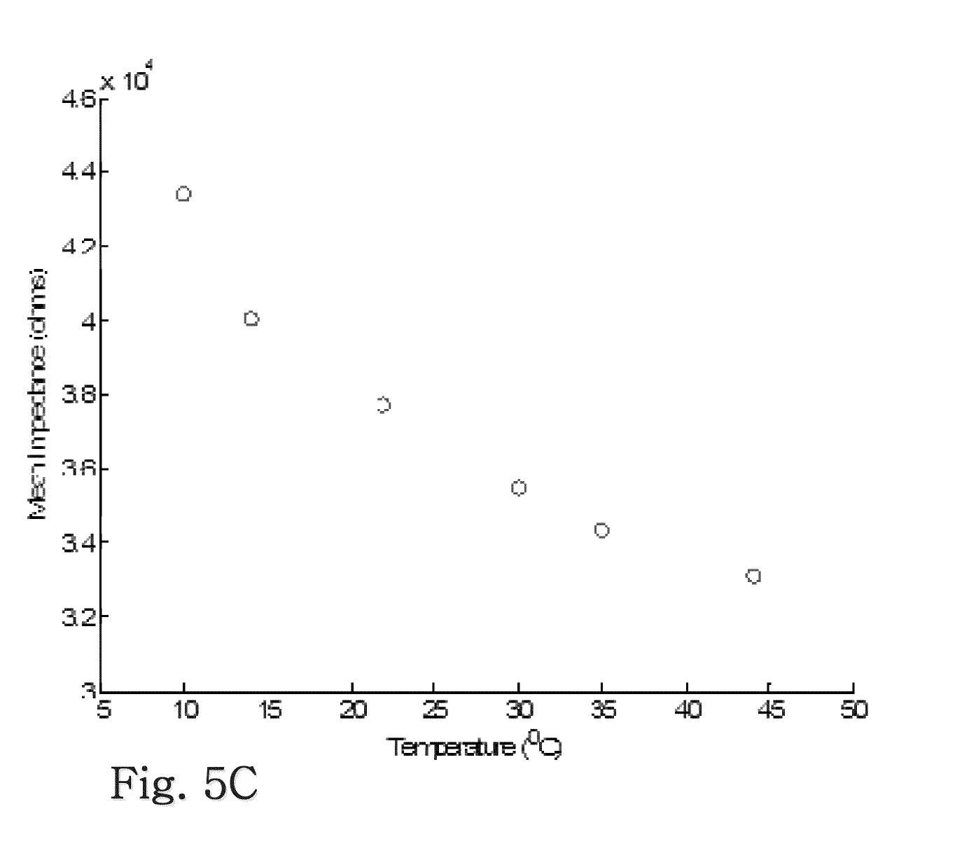

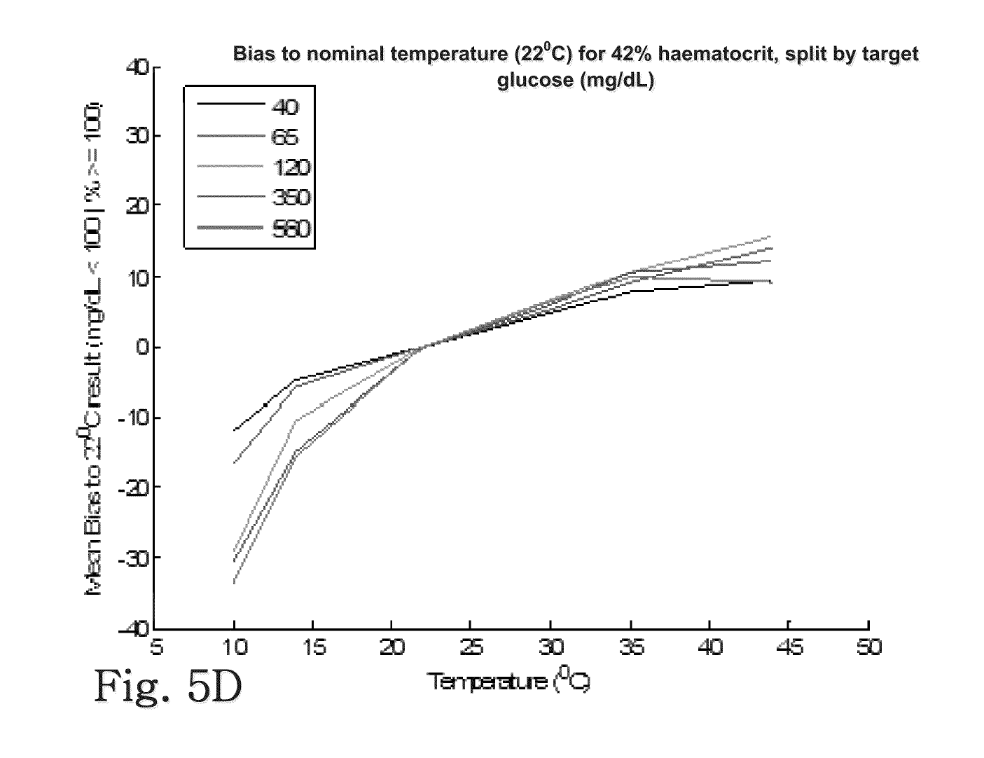

We have recently discovered that in the present measurement system described in our Earlier Applications, there are changes due to the effects of temperature (designated here as “tmp”) upon the glucose estimate and the impedance characteristic. This means that the measurement sampling time T derived at room temperature in such a system may not be appropriate at extremes of temperature for the same glucose and haematocrit combination, resulting in potential inaccuracies in the meter output result. This problem is illustrated in relation to FIGS. 5A and 5B.

In FIG. 5A, the performance of our known technique (in which a measurement is taken at around 5 seconds for various glucose values and hematocrits) are tested at 22 degrees C. and 44 degrees C. Because the test involves temperatures at 22 degrees C. and 44 degrees C., FIG. 5A is divided into left and right panels. In the left panel of FIG. 5A, the sensitivity of the system to hematocrit at 22 degrees C. for various glucose measurements as compared to referential targets (i.e., bias) are shown as being within ±0.5% at 100 mg/dL or below (reference numeral 502). While still at 22 degrees C., the bias starts to increase as the target glucose concentration increases (from 100 mg/dL to 400 mg/dL), as referenced in numeral 504. When the prior system is tested at 44 degrees C., a similar pattern of increasing sensitivity to hematocrit emerges, shown here in the right panel for FIG. 5A. In the right panel of FIG. 5A, in which all measurements were made at 44 degrees C., the bias are generally within acceptable range when the referential glucose is about 100 degrees C. or even less bias at 506. However, at referential glucose above 100 mg/dL, the bias or error can be seen to be increasing at 508 such that the bias is outside of acceptable range.

In FIG. 5B, the same experimental set (used in FIG. 5A) was used with a technique from our Earlier Applications in which a measurement sampling time T is selected as a function of (a) an estimated measurement G_{E} taken at a predetermined time (e.g., about 2.5 seconds) and (b) a physical characteristic of the fluid sample as represented by an impedance characteristic IC of the sample. In the left panel of FIG. 5B, it can be seen that the bias or error is within acceptable range when the system is tested at 22 degrees C. for glucose concentration less than 100 mg/dL to over 300 mg/dL, as indicated at 510. At 44 degrees C. (right panel of FIG. 5B), the bias or error with respect to hematocrits are generally within range for referential or target glucose concentration above approximately 250 mg/dL, indicated at 512. However, for referential glucose concentration below approximately 250 mg/dL to 100 mg/dL or less, the bias or error increases substantially with the test at 44 degrees C., indicated here at 514.

Thus, we have devised a heretofore novel technique to improve on our Earlier Techniques. In particular, this new technique utilizes a determination of a glucose estimate or G_{E} taken at about 2.5 seconds by sampling or measuring signal from both working electrodes, calculating the sum of the measured output signals then applying a slope and intercept term to determine the glucose concentration estimate. The equation to calculate estimate glucose from the sum of WE1 and WE2 signal is given in Equation 6, where G_{E} is the estimate glucose, I_{WE, 2.54 s} is the signal (or current in nanoamps) at 2.54 seconds, c_{E} is the intercept and m_{E} is the slope. In Equation 6, the values of m_{E} is about 12.1 nA/mg/dL and c_{E} is about 600 nA.

$${G}_{E} = \frac{{\sum }_{WE = 1}^{2} {I}_{WE \cdot 2.54 s} - {c}_{E}}{{m}_{E}} \qquad Eq . 6$$

It is also noted that the impedance and glucose estimate inputs to our techniques are both sensitive to temperature, shown here respectively as FIG. 5C and FIG. 5D in which the impedance in FIG. 5C is shown to be changing as the temperature tmp changes and the mean bias (or error) can be seen in FIG. 5D as changing in relation to changes in the measured temperature tmp. To correct for the effect of temperature, we have devised a technique in which the glucose estimate (G_{E}) is compensated for temperature effect, designated in Equation 7 as G_{ETC}:

G_{ETC}=G00+G10*G_{E}+G01*(tmp−t₀)+G11*G_{E}*(tmp−t₀)+G02*(tmp−t₀)²+G12*G_{E}*(tmp−t₀)²+G03*(tmp−t₀)³ Eq. 7

Where G_{E} is the estimate glucose from Error! Reference source not found., tmp is the meter temperature and t₀ is the nominal temperature (22° C.). All coefficients are summarized in Table 2:

TABLE 2

| Coefficient | Value |
|---|---|
| G00 | −0.3205 |
| G10 | 1.0659 |
| G01 | 0.225 |
| G11 | −0.022 |
| G02 | 0.0319 |
| G12 | 0.0008 |
| G03 | −0.0026 |

The physical characteristic, as represented by impedance characteristic is compensated by Equation 8:

|Z|_{TC}=M00+M10*|Z|+M01*(tmp−t₀)+M11*|Z|*(tmp−t₀)+M02*(tmp−t₀)² Eq. 8
Where |Z|_{TC} is the magnitude of the temperature compensated impedance and
tmp is the temperature and t₀ is the nominal temperature (22° C.). All coefficients are summarized in the following Table 3:

TABLE 3

| Coefficient | Value |
|---|---|
| M00 | 1115.906 |
| M10 | 0.976 |
| M01 | −125.188 |
| M11 | 0.0123 |
| M02 | −3.851 |

In one implementation of our technique, various tables (Tables 4-8) were developed as being indexed to the measured temperature tmp during the test sequence. That is, the appropriate table (in which the time T is found) is specified by the measured temperature tmp. Once the appropriate table is obtained, the column of that table is specified by impedance characteristic (or |Z|_{TC}) and its row by G_{ETC}. There is only one assay time T available for each fluid sample (e.g., blood or control solution) at the measured temperature tmp as determined by the system inputs. The column headers provide the boundaries for impedance characteristic IC (designated as |Z|_{TC}) for each column. The change in the first and final column headers from each of Tables 4-8 is defined by 6 standard deviations from the mean temperature corrected impedance at the extremes of temperature and haematocrit. This was done to prevent the meter from returning an error when the magnitude of | impedance characteristic IC (designated as |Z|_{TC}) is deemed within range. The temperature compensated glucose estimate GETC values within each table indicate the upper glucose boundary for the row. The last row is applied to all glucose estimates above 588 mg/dL.

The five tables for selecting the appropriate sampling time are defined by the temperature thresholds tmp1, tmp2, tmp3, and tmp4. These tables are illustrated as Table 4 to Table 8, respectively. In Table 4, the threshold tmp1 is designated as about 15 degrees C.; in Table 5, tmp2 is designated as about 20 degrees C.; in Table 6, tmp3 is designated as about 28 degrees C.; in Table 7, tmp4 is designated as 33 about degrees C.; and in Table 8, tmp5 is designated as about 40 degrees C. It should be noted that these values for temperature ranges are for the system described herein and that actual values may differ depending on the parameter of the test strip and meter utilized and we do not intend to be bound by these values for the scope of our claims.

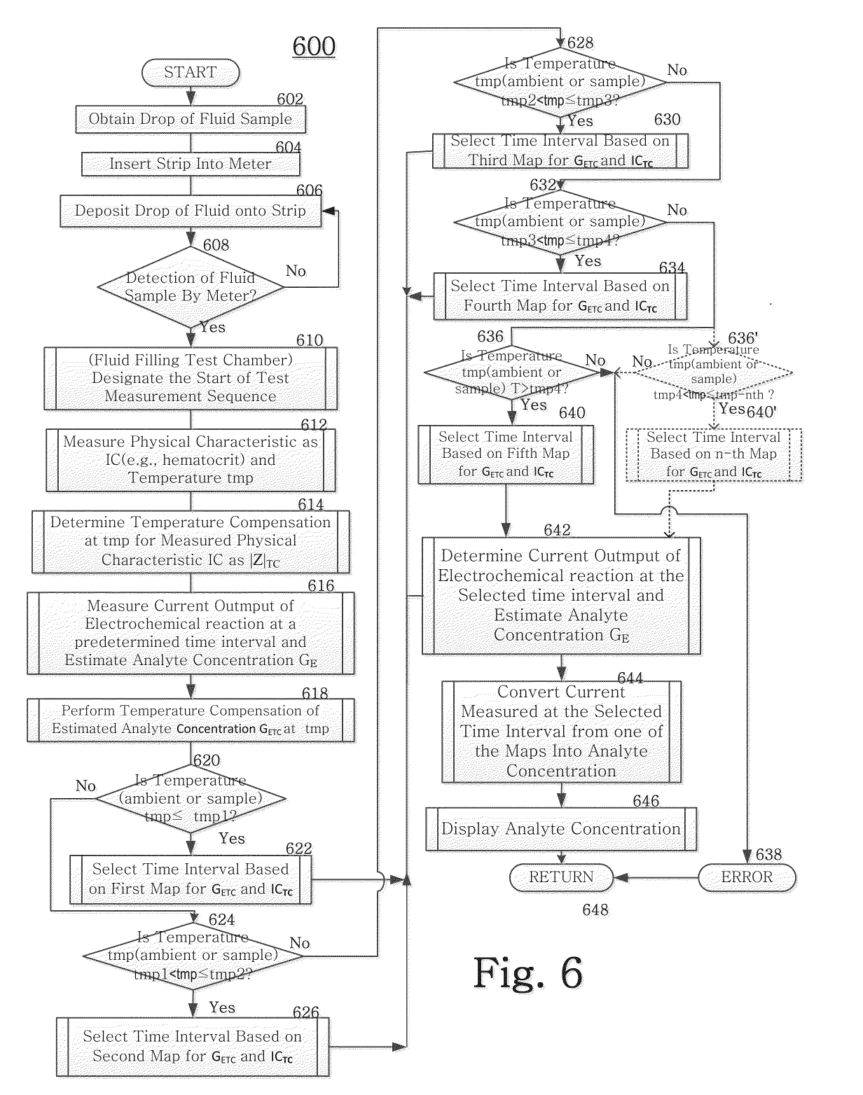

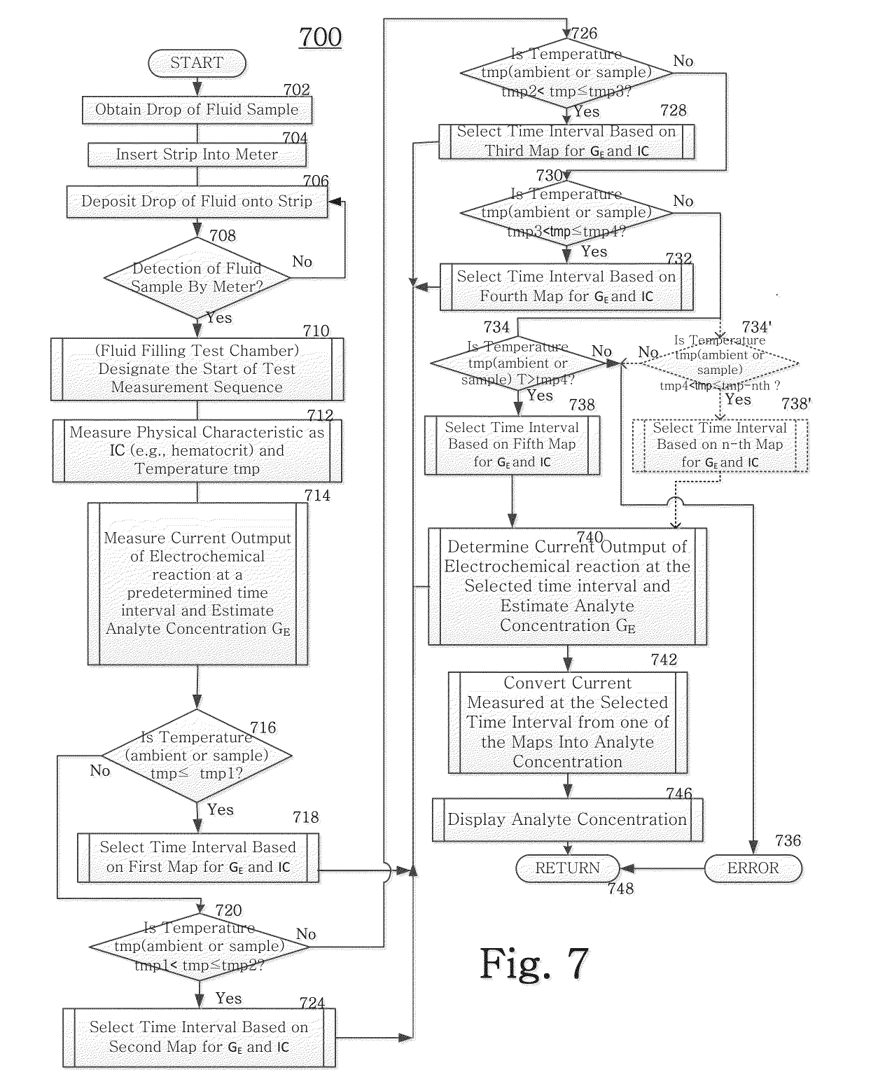

At this point it is worthwhile to describe the techniques that we have devised with reference to FIGS. 6 and 7. Starting in FIG. 6, the microcontroller described earlier can be configured to perform a series of steps during operation of the meter and strip system. In particular, at step 606, a fluid sample can be deposited onto the test chamber of the test strip and the test strip is inserted into the meter (step 604). The microprocessor starts a test assaying sequence watch at step 608 to determine when to start the test sequence (i.e., setting the start test sequence clock) upon deposition of a sample, and once fluid sample is detected (returning a “yes” at step 608), the microprocessor applies an input signal at step 612 to the sample to determine a physical characteristic signal representative of the sample. This input signal is generally an alternating signal so that the physical characteristic (in the form of impedance) of the sample can be obtained. At around the same time, the measured temperature tmp of one of the sample, test strip or meter can also be determined (via a thermistor built into the meter) for temperature compensation of the impedance. The temperature compensation can be made to the impedance characteristic (as discussed with Equation 8 above) at step 614. At step 616, the microcontroller drives another signal to the sample and measures at least one output signal from at least one of the electrodes to derive an estimated analyte concentration G_{E} from the at least one output signal at one of a plurality of predetermined time intervals as referenced from the start of the test sequence. At step 618, the processor performs a temperature compensation for the estimated analyte concentration based on the measured temperature tmp. The processor then select an analyte measurement sampling time point T or time interval from suitable calculations with respect to the start of the test sequence based on (1) the temperature compensated value of the physical characteristic signal |Z|_{TC} and (2) the temperature compensated value of the estimated analyte concentration G_{ETC}. To save on processing power, a plurality of look-up tables can be used that correspond to Tables 4-8 instead of the processor performing extensive calculations to arrive at the specified sampling time T (at one of steps 622, 626, 630, 634, 636 and so on) on the basis of (1) measured temperature (tmp); (2) temperature compensated glucose estimate G_{ETC}; and (3) the temperature compensated physical characteristic signal or impedance |Z|_{TC}. The processor at step 644 calculates an analyte concentration based on a magnitude of the output signals at the selected analyte measurement sampling time point or time interval T obtained in one of steps 622, 626, 630, 634, 636 and so on such as in step 636′. It is noted that an error trap is built into the logic 600 to prevent an endless loop by setting an upper limit at step 636 (or step 636′) which returns an error at step 638. If there is no error at step 636 (or 636′), the processor may annunciate the analyte concentration via a screen or audio output at step 646.

As an example, it is assumed that Table 4 is selected due to the measured temperature tmp is less than tmp1. Therefore, if the compensated physical characteristic IC (referenced here as |Z|_{TC}) from step 614 is determined as a value of between 48605 ohms and 51,459 ohms and the estimated and compensated glucose G_{ETC} at step 618 returns a value of greater than about 163 and less than or equal to about 188 mg/dL then the system selects the measurement sampling time T as about 3.8 seconds, shown here with emphasis in Table 4.

TABLE 4
First Measurement Time Sampling Map (bolded number indicates time
in seconds)
FIRST MAP FOR ANALYTE SAMPLING TIME “T” INDEXED TO tmp ≦ tmp1

| | | \|Z_{TC}\| (ohms) | | | | | | | | | | | | |
|---|---|---|---|---|---|---|---|---|---|---|---|---|---|---|
| | | 19000 | 30052 | 31380 | 32707 | 34035 | 35523 | 37031 | 38807 | 40943 | 43078 | 45752 | 48605 | 51459 |
| | | 30052 | 31380 | 32707 | 34035 | 35523 | 37031 | 38807 | 40943 | 43078 | 45752 | 48605 | 51459 | 66000 |
| G_{ETC} | 38 | 5.2 | 5.2 | 5.2 | 5.1 | 5.1 | 5.1 | 5 | 4.9 | 4.9 | 4.8 | 4.7 | 4.6 | 4.5 |
| (mg/ | 63 | 5.4 | 5.4 | 5.3 | 5.2 | 5.2 | 5.1 | 5 | 4.9 | 4.8 | 4.7 | 4.6 | 4.5 | 4.3 |
| dL) | 88 | 5.6 | 5.5 | 5.5 | 5.4 | 5.2 | 5.1 | 5 | 4.9 | 4.8 | 4.6 | 4.5 | 4.3 | 4.2 |
| | 113 | 5.8 | 5.7 | 5.5 | 5.4 | 5.3 | 5.2 | 5 | 4.9 | 4.7 | 4.5 | 4.3 | 4.2 | 4 |
| | 138 | 6 | 5.8 | 5.7 | 5.5 | 5.4 | 5.2 | 5 | 4.8 | 4.6 | 4.5 | 4.3 | 4 | 3.9 |
| | 163 | 6.1 | 6 | 5.8 | 5.5 | 5.4 | 5.2 | 5 | 4.8 | 4.6 | 4.3 | 4.2 | 3.9 | 3.7 |
| | 188 | 6.3 | 6 | 5.8 | 5.6 | 5.4 | 5.2 | 4.9 | 4.8 | 4.5 | 4.3 | 4 | 3.8 | 3.6 |
| | 213 | 6.4 | 6.1 | 5.9 | 5.7 | 5.4 | 5.2 | 4.9 | 4.7 | 4.5 | 4.2 | 4 | 3.7 | 3.4 |
| | 238 | 6.4 | 6.2 | 6 | 5.7 | 5.4 | 5.2 | 4.9 | 4.6 | 4.4 | 4.1 | 3.9 | 3.6 | 3.3 |
| | 263 | 6.6 | 6.3 | 6 | 5.7 | 5.4 | 5.2 | 4.9 | 4.6 | 4.3 | 4 | 3.8 | 3.5 | 3.3 |
| | 288 | 6.6 | 6.3 | 6 | 5.7 | 5.4 | 5.1 | 4.8 | 4.6 | 4.3 | 4 | 3.7 | 3.4 | 3.1 |
| | 313 | 6.6 | 6.3 | 6 | 5.7 | 5.4 | 5.1 | 4.8 | 4.5 | 4.2 | 3.9 | 3.7 | 3.4 | 3.1 |
| | 338 | 6.7 | 6.4 | 6 | 5.7 | 5.4 | 5.1 | 4.8 | 4.5 | 4.2 | 3.9 | 3.6 | 3.3 | 3.1 |
| | 363 | 6.7 | 6.4 | 6 | 5.7 | 5.4 | 5.1 | 4.8 | 4.5 | 4.2 | 3.9 | 3.6 | 3.3 | 3.1 |
| | 388 | 6.7 | 6.4 | 6 | 5.7 | 5.4 | 5.1 | 4.7 | 4.4 | 4.1 | 3.8 | 3.6 | 3.3 | 3.1 |
| | 413 | 6.7 | 6.3 | 6 | 5.7 | 5.4 | 5 | 4.7 | 4.4 | 4.1 | 3.8 | 3.5 | 3.3 | 3.1 |
| | 438 | 6.7 | 6.3 | 6 | 5.7 | 5.3 | 5 | 4.7 | 4.4 | 4.1 | 3.8 | 3.5 | 3.3 | 3.1 |
| | 463 | 6.6 | 6.3 | 6 | 5.6 | 5.3 | 4.9 | 4.6 | 4.3 | 4 | 3.8 | 3.5 | 3.3 | 3.1 |
| | 488 | 6.6 | 6.3 | 5.9 | 5.6 | 5.2 | 4.9 | 4.6 | 4.3 | 4 | 3.8 | 3.6 | 3.3 | 3.1 |
| | 513 | 6.6 | 6.2 | 5.8 | 5.5 | 5.2 | 4.9 | 4.6 | 4.3 | 4.1 | 3.8 | 3.6 | 3.3 | 3.1 |
| | 538 | 6.5 | 6.1 | 5.8 | 5.5 | 5.2 | 4.9 | 4.6 | 4.3 | 4.1 | 3.9 | 3.6 | 3.4 | 3.2 |
| | 563 | 6.4 | 6.1 | 5.8 | 5.5 | 5.2 | 4.9 | 4.6 | 4.3 | 4.1 | 3.9 | 3.7 | 3.5 | 3.3 |
| | 588 | 6.3 | 6 | 5.7 | 5.4 | 5.1 | 4.9 | 4.6 | 4.4 | 4.2 | 4 | 3.7 | 3.6 | 3.4 |
| | 613 | 6.3 | 6 | 5.7 | 5.4 | 5.1 | 4.9 | 4.6 | 4.4 | 4.2 | 4 | 3.9 | 3.7 | 3.6 |

The same technique is applied in the remaining Tables 5-8, depending on the actual value of the measured temperature tmp.

TABLE 5
Second Measurement Time Sampling Map (bolded number indicates time in
seconds)
SECOND MAP FOR ANALYTE SAMPLING TIME “T” INDEXED TO
tmp1 ≦ tmp ≦ tmp2

| | | \|Z_{TC}\| (ohms) | | | | | | | | | | | | |
|---|---|---|---|---|---|---|---|---|---|---|---|---|---|---|
| | | 19000 | 30052 | 31380 | 32707 | 34035 | 35523 | 37031 | 38807 | 40943 | 43078 | 45752 | 48605 | 51459 |
| | | 30052 | 31380 | 32707 | 34035 | 35523 | 37031 | 38807 | 40943 | 43078 | 45752 | 48605 | 51459 | 66000 |
| G_{ETC} | 38 | 5.1 | 5.1 | 5.1 | 5.1 | 5 | 4.9 | 4.9 | 4.9 | 4.8 | 4.8 | 4.7 | 4.6 | 4.6 |
| (mg/ | 63 | 5.4 | 5.3 | 5.2 | 5.2 | 5.1 | 5.1 | 4.9 | 4.9 | 4.8 | 4.7 | 4.6 | 4.5 | 4.4 |
| dL) | 88 | 5.6 | 5.5 | 5.4 | 5.3 | 5.2 | 5.1 | 5 | 4.9 | 4.8 | 4.6 | 4.5 | 4.4 | 4.3 |
| | 113 | 5.8 | 5.7 | 5.5 | 5.4 | 5.3 | 5.2 | 5 | 4.9 | 4.8 | 4.6 | 4.5 | 4.3 | 4.1 |
| | 138 | 6 | 5.8 | 5.7 | 5.5 | 5.4 | 5.2 | 5.1 | 4.9 | 4.7 | 4.5 | 4.3 | 4.2 | 4 |
| | 163 | 6.1 | 6 | 5.8 | 5.6 | 5.4 | 5.2 | 5.1 | 4.9 | 4.7 | 4.5 | 4.3 | 4 | 3.9 |
| | 188 | 6.3 | 6.1 | 5.9 | 5.7 | 5.5 | 5.3 | 5.1 | 4.9 | 4.6 | 4.4 | 4.2 | 4 | 3.7 |
| | 213 | 6.4 | 6.2 | 6 | 5.8 | 5.5 | 5.3 | 5.1 | 4.8 | 4.6 | 4.4 | 4.2 | 3.9 | 3.6 |
| | 238 | 6.5 | 6.3 | 6.1 | 5.8 | 5.6 | 5.4 | 5.1 | 4.8 | 4.6 | 4.3 | 4.1 | 3.8 | 3.6 |
| | 263 | 6.6 | 6.4 | 6.1 | 5.8 | 5.6 | 5.4 | 5.1 | 4.8 | 4.6 | 4.3 | 4 | 3.7 | 3.5 |
| | 288 | 6.7 | 6.4 | 6.1 | 5.9 | 5.7 | 5.4 | 5.1 | 4.8 | 4.5 | 4.3 | 4 | 3.7 | 3.4 |
| | 313 | 6.7 | 6.5 | 6.2 | 5.9 | 5.7 | 5.4 | 5.1 | 4.8 | 4.5 | 4.2 | 3.9 | 3.7 | 3.4 |
| | 338 | 6.8 | 6.5 | 6.3 | 6 | 5.7 | 5.4 | 5.1 | 4.8 | 4.5 | 4.2 | 3.9 | 3.6 | 3.3 |
| | 363 | 6.8 | 6.6 | 6.3 | 6 | 5.7 | 5.4 | 5.1 | 4.8 | 4.5 | 4.2 | 3.9 | 3.6 | 3.3 |
| | 388 | 6.8 | 6.6 | 6.3 | 6 | 5.7 | 5.4 | 5.1 | 4.8 | 4.5 | 4.2 | 3.9 | 3.6 | 3.3 |
| | 413 | 6.8 | 6.5 | 6.3 | 6 | 5.7 | 5.4 | 5.1 | 4.8 | 4.5 | 4.2 | 3.9 | 3.6 | 3.3 |
| | 438 | 6.8 | 6.5 | 6.2 | 6 | 5.7 | 5.4 | 5.1 | 4.8 | 4.5 | 4.2 | 3.9 | 3.6 | 3.3 |
| | 463 | 6.7 | 6.5 | 6.2 | 5.9 | 5.6 | 5.4 | 5.1 | 4.8 | 4.5 | 4.2 | 3.9 | 3.6 | 3.3 |
| | 488 | 6.7 | 6.4 | 6.1 | 5.9 | 5.6 | 5.4 | 5.1 | 4.8 | 4.5 | 4.2 | 3.9 | 3.7 | 3.4 |
| | 513 | 6.6 | 6.4 | 6.1 | 5.8 | 5.6 | 5.3 | 5.1 | 4.8 | 4.5 | 4.3 | 4 | 3.7 | 3.4 |
| | 538 | 6.6 | 6.3 | 6.1 | 5.8 | 5.5 | 5.3 | 5.1 | 4.8 | 4.5 | 4.3 | 4 | 3.8 | 3.6 |
| | 563 | 6.4 | 6.2 | 6 | 5.8 | 5.5 | 5.3 | 5.1 | 4.8 | 4.6 | 4.3 | 4.1 | 3.9 | 3.6 |
| | 588 | 6.4 | 6.1 | 5.9 | 5.7 | 5.5 | 5.2 | 5.1 | 4.8 | 4.6 | 4.4 | 4.2 | 4 | 3.7 |
| | 613 | 6.3 | 6 | 5.8 | 5.7 | 5.4 | 5.2 | 5.1 | 4.9 | 4.6 | 4.5 | 4.3 | 4.1 | 3.9 |

TABLE 6
Third Measurement Time Sampling Map (bolded number indicates time
in seconds)
THIRD MAP FOR ANALYTE SAMPLING TIME tmp2 ≦ tmp ≦ tmp3

| | | \|Z_{TC}\| (ohms) | | | | | | | | | | | | |
|---|---|---|---|---|---|---|---|---|---|---|---|---|---|---|
| | | 19000 | 30052 | 31380 | 32707 | 34035 | 35523 | 37031 | 38807 | 40943 | 43078 | 45752 | 48605 | 51459 |
| | | 30052 | 31380 | 32707 | 34035 | 35523 | 37031 | 38807 | 40943 | 43078 | 45752 | 48605 | 51459 | 66000 |
| G_{ETC} | 38 | 5.1 | 5.1 | 5.1 | 5.1 | 5 | 4.9 | 4.9 | 4.9 | 4.8 | 4.8 | 4.7 | 4.6 | 4.6 |
| (mg/ | 63 | 5.4 | 5.3 | 5.2 | 5.2 | 5.1 | 5.1 | 4.9 | 4.9 | 4.8 | 4.7 | 4.6 | 4.5 | 4.4 |
| dL) | 88 | 5.6 | 5.5 | 5.4 | 5.3 | 5.2 | 5.1 | 5 | 4.9 | 4.8 | 4.6 | 4.5 | 4.4 | 4.3 |
| | 113 | 5.8 | 5.7 | 5.5 | 5.4 | 5.3 | 5.2 | 5 | 4.9 | 4.8 | 4.6 | 4.5 | 4.3 | 4.1 |
| | 138 | 6 | 5.8 | 5.7 | 5.5 | 5.4 | 5.2 | 5.1 | 4.9 | 4.7 | 4.5 | 4.3 | 4.2 | 4 |
| | 163 | 6.1 | 6 | 5.8 | 5.6 | 5.4 | 5.2 | 5.1 | 4.9 | 4.7 | 4.5 | 4.3 | 4 | 3.9 |
| | 188 | 6.3 | 6.1 | 5.9 | 5.7 | 5.5 | 5.3 | 5.1 | 4.9 | 4.6 | 4.4 | 4.2 | 4 | 3.7 |
| | 213 | 6.4 | 6.2 | 6 | 5.8 | 5.5 | 5.3 | 5.1 | 4.8 | 4.6 | 4.4 | 4.2 | 3.9 | 3.6 |
| | 238 | 6.5 | 6.3 | 6.1 | 5.8 | 5.6 | 5.4 | 5.1 | 4.8 | 4.6 | 4.3 | 4.1 | 3.8 | 3.6 |
| | 263 | 6.6 | 6.4 | 6.1 | 5.8 | 5.6 | 5.4 | 5.1 | 4.8 | 4.6 | 4.3 | 4 | 3.7 | 3.5 |
| | 288 | 6.7 | 6.4 | 6.1 | 5.9 | 5.7 | 5.4 | 5.1 | 4.8 | 4.5 | 4.3 | 4 | 3.7 | 3.4 |
| | 313 | 6.7 | 6.5 | 6.2 | 5.9 | 5.7 | 5.4 | 5.1 | 4.8 | 4.5 | 4.2 | 3.9 | 3.7 | 3.4 |
| | 338 | 6.8 | 6.5 | 6.3 | 6 | 5.7 | 5.4 | 5.1 | 4.8 | 4.5 | 4.2 | 3.9 | 3.6 | 3.3 |
| | 363 | 6.8 | 6.6 | 6.3 | 6 | 5.7 | 5.4 | 5.1 | 4.8 | 4.5 | 4.2 | 3.9 | 3.6 | 3.3 |
| | 388 | 6.8 | 6.6 | 6.3 | 6 | 5.7 | 5.4 | 5.1 | 4.8 | 4.5 | 4.2 | 3.9 | 3.6 | 3.3 |
| | 413 | 6.8 | 6.5 | 6.3 | 6 | 5.7 | 5.4 | 5.1 | 4.8 | 4.5 | 4.2 | 3.9 | 3.6 | 3.3 |
| | 438 | 6.8 | 6.5 | 6.2 | 6 | 5.7 | 5.4 | 5.1 | 4.8 | 4.5 | 4.2 | 3.9 | 3.6 | 3.3 |
| | 463 | 6.7 | 6.5 | 6.2 | 5.9 | 5.6 | 5.4 | 5.1 | 4.8 | 4.5 | 4.2 | 3.9 | 3.6 | 3.3 |
| | 488 | 6.7 | 6.4 | 6.1 | 5.9 | 5.6 | 5.4 | 5.1 | 4.8 | 4.5 | 4.2 | 3.9 | 3.7 | 3.4 |
| | 513 | 6.6 | 6.4 | 6.1 | 5.8 | 5.6 | 5.3 | 5.1 | 4.8 | 4.5 | 4.3 | 4 | 3.7 | 3.4 |
| | 538 | 6.6 | 6.3 | 6.1 | 5.8 | 5.5 | 5.3 | 5.1 | 4.8 | 4.5 | 4.3 | 4 | 3.8 | 3.6 |
| | 563 | 6.4 | 6.2 | 6 | 5.8 | 5.5 | 5.3 | 5.1 | 4.8 | 4.6 | 4.3 | 4.1 | 3.9 | 3.6 |
| | 588 | 6.4 | 6.1 | 5.9 | 5.7 | 5.5 | 5.2 | 5.1 | 4.8 | 4.6 | 4.4 | 4.2 | 4 | 3.7 |
| | 613 | 6.3 | 6 | 5.8 | 5.7 | 5.4 | 5.2 | 5.1 | 4.9 | 4.6 | 4.5 | 4.3 | 4.1 | 3.9 |

TABLE 7
Fourth Measurement Time Sampling Map (bolded number indicates
time in seconds)
FOURTH MAP FOR ANALYTE SAMPLING TIME “T” INDEXED TO
tmp3 ≦ tmp ≦ tmp4

| | | \|Z_{TC}\| (ohms) | | | | | | | | | | | | |
|---|---|---|---|---|---|---|---|---|---|---|---|---|---|---|
| | | 19000 | 30052 | 31380 | 32707 | 34035 | 35523 | 37031 | 38807 | 40943 | 43078 | 45752 | 48605 | 51459 |
| | | 30052 | 31380 | 32707 | 34035 | 35523 | 37031 | 38807 | 40943 | 43078 | 45752 | 48605 | 51459 | 66000 |
| G_{ETC} | 38 | 4.6 | 4.7 | 4.8 | 4.8 | 4.9 | 4.9 | 5 | 5.1 | 5.1 | 5.1 | 5.2 | 5.2 | 5.2 |
| (mg/ | 63 | 4.8 | 4.8 | 4.9 | 4.9 | 4.9 | 5 | 5 | 5 | 5 | 5 | 5 | 4.9 | 4.9 |
| dL) | 88 | 5 | 5 | 5 | 5 | 5 | 5 | 5 | 5 | 4.9 | 4.9 | 4.8 | 4.8 | 4.7 |
| | 113 | 5.2 | 5.2 | 5.1 | 5.1 | 5.1 | 5.1 | 5 | 4.9 | 4.9 | 4.8 | 4.7 | 4.6 | 4.5 |
| | 138 | 5.4 | 5.3 | 5.2 | 5.2 | 5.1 | 5.1 | 5 | 4.9 | 4.8 | 4.7 | 4.6 | 4.5 | 4.3 |
| | 163 | 5.5 | 5.4 | 5.4 | 5.3 | 5.2 | 5.1 | 5 | 4.9 | 4.8 | 4.6 | 4.5 | 4.3 | 4.2 |
| | 188 | 5.7 | 5.6 | 5.5 | 5.4 | 5.2 | 5.1 | 5 | 4.9 | 4.7 | 4.6 | 4.4 | 4.2 | 4 |
| | 213 | 5.8 | 5.7 | 5.5 | 5.4 | 5.3 | 5.2 | 5 | 4.8 | 4.7 | 4.5 | 4.3 | 4.2 | 3.9 |
| | 238 | 6 | 5.8 | 5.7 | 5.5 | 5.4 | 5.2 | 5 | 4.8 | 4.6 | 4.5 | 4.3 | 4 | 3.9 |
| | 263 | 6 | 5.9 | 5.7 | 5.5 | 5.4 | 5.2 | 5 | 4.8 | 4.6 | 4.4 | 4.2 | 4 | 3.7 |
| | 288 | 6.1 | 6 | 5.8 | 5.6 | 5.4 | 5.2 | 5.1 | 4.8 | 4.6 | 4.4 | 4.2 | 3.9 | 3.7 |
| | 313 | 6.2 | 6 | 5.8 | 5.7 | 5.5 | 5.2 | 5.1 | 4.8 | 4.6 | 4.3 | 4.1 | 3.9 | 3.6 |
| | 338 | 6.3 | 6.1 | 5.9 | 5.7 | 5.5 | 5.3 | 5.1 | 4.8 | 4.6 | 4.3 | 4.1 | 3.9 | 3.6 |
| | 363 | 6.3 | 6.1 | 6 | 5.7 | 5.5 | 5.3 | 5.1 | 4.8 | 4.6 | 4.3 | 4.1 | 3.8 | 3.6 |
| | 388 | 6.4 | 6.2 | 6 | 5.7 | 5.5 | 5.3 | 5.1 | 4.8 | 4.6 | 4.3 | 4 | 3.8 | 3.5 |
| | 413 | 6.4 | 6.2 | 6 | 5.8 | 5.5 | 5.3 | 5.1 | 4.8 | 4.6 | 4.3 | 4 | 3.8 | 3.5 |
| | 438 | 6.4 | 6.2 | 6 | 5.8 | 5.5 | 5.3 | 5.1 | 4.8 | 4.6 | 4.3 | 4 | 3.8 | 3.5 |
| | 463 | 6.4 | 6.1 | 6 | 5.7 | 5.5 | 5.3 | 5.1 | 4.8 | 4.6 | 4.3 | 4 | 3.8 | 3.6 |
| | 488 | 6.3 | 6.1 | 5.9 | 5.7 | 5.5 | 5.3 | 5.1 | 4.8 | 4.6 | 4.3 | 4.1 | 3.8 | 3.6 |
| | 513 | 6.3 | 6.1 | 5.9 | 5.7 | 5.5 | 5.2 | 5.1 | 4.8 | 4.6 | 4.3 | 4.1 | 3.9 | 3.6 |
| | 538 | 6.2 | 6 | 5.8 | 5.6 | 5.4 | 5.2 | 5 | 4.8 | 4.6 | 4.3 | 4.1 | 3.9 | 3.6 |
| | 563 | 6.1 | 5.9 | 5.7 | 5.5 | 5.4 | 5.2 | 5 | 4.8 | 4.6 | 4.3 | 4.2 | 3.9 | 3.7 |
| | 588 | 6 | 5.8 | 5.7 | 5.5 | 5.3 | 5.1 | 4.9 | 4.8 | 4.6 | 4.3 | 4.2 | 4 | 3.7 |
| | 613 | 5.8 | 5.7 | 5.5 | 5.4 | 5.2 | 5.1 | 4.9 | 4.7 | 4.6 | 4.4 | 4.2 | 4 | 3.8 |

TABLE 8
Fifth Measurement Time Sampling Map (bolded number indicates time in
seconds)
FIFTH MAP FOR ANALYTE SAMPLING TIME “T” INDEXED TO tmp > tmp4

| | | \|Z_{TC}\| (ohms) | | | | | | | | | | | | |
|---|---|---|---|---|---|---|---|---|---|---|---|---|---|---|
| | | 19000 | 30052 | 31380 | 32707 | 34035 | 35523 | 37031 | 38807 | 40943 | 43078 | 45752 | 48605 | 51459 |
| | | 30052 | 31380 | 32707 | 34035 | 35523 | 37031 | 38807 | 40943 | 43078 | 45752 | 48605 | 51459 | 66000 |
| G_{ETC} | 38 | 4.3 | 4.4 | 4.5 | 4.6 | 4.7 | 4.8 | 4.9 | 5 | 5.1 | 5.2 | 5.4 | 5.5 | 5.6 |
| (mg/ | 63 | 4.6 | 4.6 | 4.7 | 4.8 | 4.8 | 4.9 | 4.9 | 5.1 | 5.1 | 5.2 | 5.2 | 5.4 | 5.4 |
| dL) | 88 | 4.8 | 4.9 | 4.9 | 4.9 | 4.9 | 5 | 5 | 5.1 | 5.1 | 5.1 | 5.2 | 5.2 | 5.2 |
| | 113 | 5.1 | 5.1 | 5.1 | 5.1 | 5.1 | 5.1 | 5.1 | 5.1 | 5.1 | 5.1 | 5.1 | 5.1 | 5.1 |
| | 138 | 5.2 | 5.2 | 5.2 | 5.1 | 5.1 | 5.1 | 5.1 | 5.1 | 5 | 5 | 5 | 4.9 | 4.9 |
| | 163 | 5.4 | 5.4 | 5.3 | 5.2 | 5.2 | 5.1 | 5.1 | 5 | 5 | 4.9 | 4.9 | 4.8 | 4.8 |
| | 188 | 5.5 | 5.5 | 5.4 | 5.3 | 5.2 | 5.2 | 5.1 | 5 | 4.9 | 4.9 | 4.8 | 4.7 | 4.6 |
| | 213 | 5.7 | 5.5 | 5.5 | 5.4 | 5.3 | 5.2 | 5.1 | 5 | 4.9 | 4.8 | 4.7 | 4.6 | 4.5 |
| | 238 | 5.8 | 5.7 | 5.5 | 5.4 | 5.3 | 5.2 | 5.1 | 4.9 | 4.8 | 4.7 | 4.6 | 4.5 | 4.3 |
| | 263 | 5.8 | 5.7 | 5.6 | 5.5 | 5.3 | 5.2 | 5.1 | 4.9 | 4.8 | 4.6 | 4.5 | 4.3 | 4.2 |
| | 288 | 5.9 | 5.8 | 5.6 | 5.5 | 5.4 | 5.2 | 5.1 | 4.9 | 4.8 | 4.6 | 4.4 | 4.3 | 4.1 |
| | 313 | 6 | 5.8 | 5.7 | 5.5 | 5.4 | 5.2 | 5 | 4.9 | 4.7 | 4.5 | 4.3 | 4.2 | 4 |
| | 338 | 6 | 5.8 | 5.7 | 5.5 | 5.4 | 5.2 | 5 | 4.8 | 4.6 | 4.5 | 4.3 | 4.1 | 3.9 |
| | 363 | 6 | 5.8 | 5.7 | 5.5 | 5.4 | 5.2 | 5 | 4.8 | 4.6 | 4.4 | 4.2 | 4 | 3.8 |
| | 388 | 6 | 5.8 | 5.7 | 5.5 | 5.3 | 5.1 | 4.9 | 4.8 | 4.6 | 4.4 | 4.2 | 4 | 3.7 |
| | 413 | 6 | 5.8 | 5.7 | 5.5 | 5.3 | 5.1 | 4.9 | 4.8 | 4.6 | 4.3 | 4.2 | 3.9 | 3.7 |
| | 438 | 6 | 5.8 | 5.7 | 5.5 | 5.3 | 5.1 | 4.9 | 4.8 | 4.6 | 4.3 | 4.2 | 3.9 | 3.7 |
| | 463 | 6 | 5.8 | 5.7 | 5.5 | 5.3 | 5.1 | 4.9 | 4.8 | 4.6 | 4.3 | 4.2 | 3.9 | 3.7 |
| | 488 | 5.9 | 5.8 | 5.6 | 5.5 | 5.3 | 5.1 | 4.9 | 4.8 | 4.6 | 4.3 | 4.2 | 3.9 | 3.7 |
| | 513 | 5.8 | 5.7 | 5.6 | 5.4 | 5.3 | 5.1 | 4.9 | 4.8 | 4.6 | 4.4 | 4.2 | 4 | 3.7 |
| | 538 | 5.8 | 5.7 | 5.6 | 5.4 | 5.3 | 5.1 | 5 | 4.8 | 4.6 | 4.5 | 4.2 | 4 | 3.8 |
| | 563 | 5.8 | 5.7 | 5.5 | 5.4 | 5.3 | 5.2 | 5 | 4.9 | 4.7 | 4.5 | 4.3 | 4.1 | 3.9 |
| | 588 | 5.7 | 5.7 | 5.5 | 5.4 | 5.3 | 5.2 | 5.1 | 4.9 | 4.8 | 4.6 | 4.4 | 4.2 | 4 |
| | 613 | 5.7 | 5.6 | 5.5 | 5.4 | 5.4 | 5.2 | 5.1 | 5 | 4.8 | 4.7 | 4.5 | 4.3 | 4.2 |

The output signals (usually in nanoamps) measured at T (with T being selected from one of the Tables 4-8) are then used in step 644 (FIG. 6) to calculate the glucose concentration G_{U} in Equation 9:

$${G}_{U} = \frac{{\sum }_{WE = 1}^{2} {I}_{WE , {t}_{final}} - c}{m} \qquad Eq . 9$$

The values of m is about 9.2 nA/mg/dL and c is about 350 nA from the calibration of the material set batches at a nominal assay time of about 5 seconds. The glucose concentration G_{U} from Eq. 9 is then annunciated by a display screen or an audio output at step 646.

Instead of using temperature compensated glucose estimate G_{ETC} and temperature compensated impedance characteristic (or |Z|_{TC}) as inputs for each of the Tables 4-8, the tables can utilize the uncompensated glucose estimate G_{E} and uncompensated |Z| but the measurement times T in the tables can be normalized with respect to referential glucose targets at each temperature range that covers the measured temperature tmp. This is shown in another variation of our invention, illustrated here in FIG. 7.

FIG. 7 is similar in most respects to FIG. 6 and therefore similar steps between FIGS. 6 and 7 are not repeated here. However, it is noted that there is neither compensation of the glucose estimate nor the compensation of the impedance characteristic for the technique in FIG. 7. The selection of measurement time T is then dependent upon a plurality of maps whereby each map is correlated to the measured temperature tmp, the uncompensated glucose G_{E} at the measured temperature tmp and the uncompensated impedance |Z| at the measured temperature tmp.

Results.

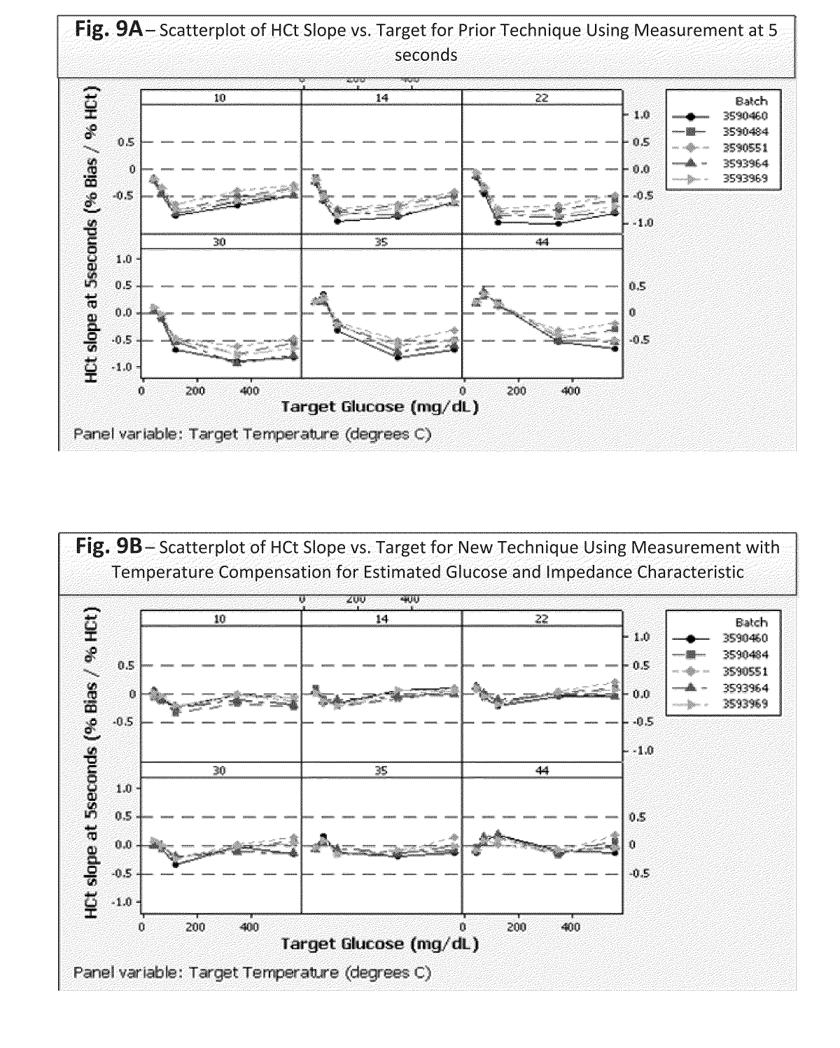

Our technique was utilized on 5 batches of test strips selected from 3 separate lots of carbon material. All reagent inks were of the same type. The test strip batches were tested in a haematocrit test experiment (5 glucose levels (40, 65, 120, 350 and 560 in mg/dL) and 3 haematocrit levels (29, 42, 56%) at temperatures of 10, 14, 22, 30, 35 and 44 degrees C. The haematocrit sensitivity of the known technique at 5 seconds (in our line of Ultra test strip) is shown in FIG. 9A and the haematocrit sensitivity of our latest technique is shown in FIG. 9B.

In the known technique of FIG. 9A, it can be seen that in the panel for 10 degrees C. (the top left panel of FIG. 9A), the sensitivity to hematocrit is outside the acceptable range of 0.5% bias per % hematocrit from about 100 mg/dL to about 400 mg/dL and as temperature increases to 14 degrees C. (center panel) to 20 degrees C. (right panel top) in FIG. 9A, the error increases for increasing glucose value. From 30 degrees C. (left bottom panel of FIG. 9A) to 35 degrees (center bottom panel) to 44 degrees C. (right bottom panel of FIG. 9A), the sensitivity to hematocrit is within the acceptable range of ±0.5% per % hematocrit.

With our present technique, the results in FIG. 9B are in sharp contrast to our prior results (FIG. 9A). The error or bias is virtually identical from 10 degrees C., 14, 22, 30, 35, and 44 degrees C. Thus, differences in the hematocrit sensitivity across a wide temperature range (e.g., 10-44 degrees C.) are mitigated to thereby improving the glucose measurement.

Although the method may specify only one analyte measurement sampling time point, the method may include sampling as many time points as required, such as, for example, sampling the signal output continuously (e.g., at specified analyte measurement sampling time such as, every 1 milliseconds to 100 milliseconds) from the start of the test sequence until at least about 10 seconds after the start and the results stored for processing near the end of the test sequence. In this variation, the sampled signal output at the specified analyte measurement sampling time point (which may be different from the predetermined analyte measurement sampling time point) is the value used to calculate the analyte concentration.

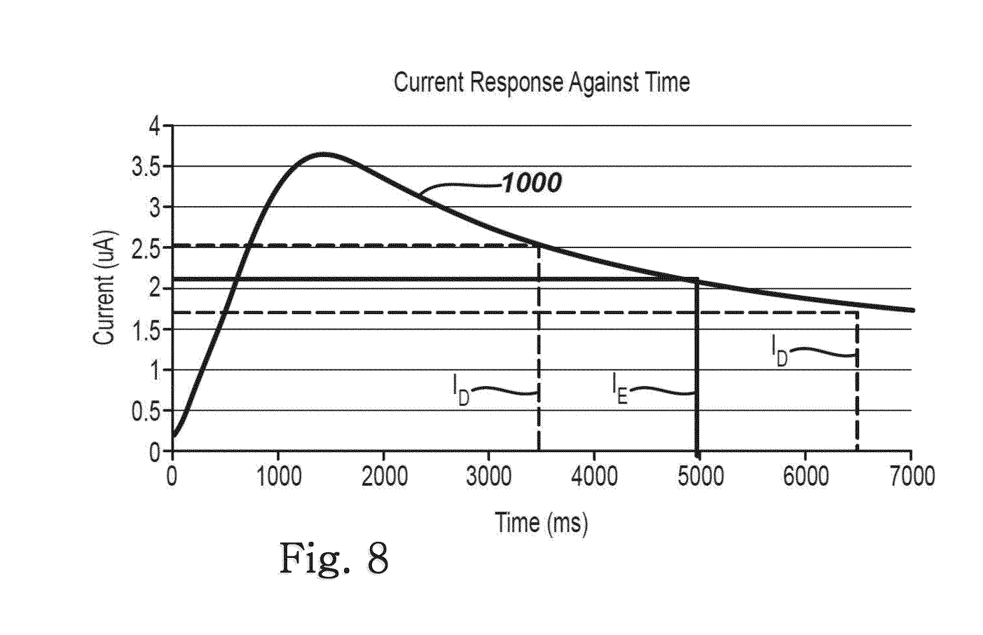

It is noted that in the preferred embodiments, the measurement of a signal output for the value that is somewhat proportional to analyte (e.g., glucose) concentration is performed prior to the estimation of the hematocrit. Alternatively, the hematocrit level can be estimated prior to the measurement of the preliminary glucose concentration. In either case, the estimated glucose measurement G_{E} is obtained by Equation 3.3 with I_{E} sampled at about one of 2.5 seconds or 5 seconds, as in FIG. 8, the physical characteristic signal (e.g., Hct) is obtained by Equation 4 and the glucose measurement G is obtained by using the measured signal output I_{D} at the designated analyte measurement sampling time point(s) (e.g., the measured signal output I_{D} being sampled at 3.5 seconds or 6.5 seconds) for the signal transient 1000.

Although the techniques described herein have been directed to determination of glucose, the techniques can also applied to other analytes (with appropriate modifications by those skilled in the art) that are affected by physical characteristic(s) of the fluid sample in which the analyte(s) is disposed in the fluid sample. For example, the physical characteristic signal (e.g., hematocrit, viscosity or density and the like) of a physiological fluid sample could be accounted for in determination of ketone or cholesterol in the fluid sample, which may be physiological fluid, calibration, or control fluid. Other biosensor configurations can also be utilized. For example, the biosensors shown and described in the following US patents can be utilized with the various embodiments described herein: U.S. Pat. Nos. 6,179,979; 6,193,873; 6,284,125; 6,413,410; 6,475,372; 6,716,577; 6,749,887; 6,863,801; 6,890,421; 7,045,046; 7,291,256; 7,498,132, all of which are incorporated by reference in their entireties herein.

As is known, the detection of the physical characteristic signal does not have to be done by alternating signals but can be done with other techniques. For example, a suitable sensor can be utilized (e.g., US Patent Application Publication No. 20100005865 or EP1804048 B1) to determine the viscosity or other physical characteristics. Alternatively, the viscosity can be determined and used to derive for hematocrits based on the known relationship between hematocrits and viscosity as described in “Blood Rheology and Hemodynamics” by Oguz K. Baskurt, M. D., Ph.D., 1 and Herbert J. Meiselman, Sc.D., Seminars in Thrombosis and Hemostasis, volume 29, number 5, 2003.

As described earlier, the microcontroller or an equivalent microprocessor (and associated components that allow the microcontroller to function for its intended purpose in the intended environment such as, for example, the processor 300 in FIG. 2B) can be utilized with computer codes or software instructions to carry out the methods and techniques described herein. Applicants note that the exemplary microcontroller 300 (along with suitable components for functional operation of the processor 300) in FIG. 2B is embedded with firmware or loaded with computer software representative of the logic diagrams in FIGS. 6 and 7 while the microcontroller 300, along with associated connector 220 and interface 306 and equivalents thereof, are the means for: (a) determining a specified analyte measurement sampling time based on a sensed or estimated physical characteristic, the specified analyte measurement sampling time being at least one time point or interval referenced from a start of a test sequence upon deposition of a sample on the test strip and (b) determining an analyte concentration based on the specified analyte measurement sampling time point.

Moreover, while the invention has been described in terms of particular variations and illustrative figures, those of ordinary skill in the art will recognize that the invention is not limited to the variations or figures described. In addition, where methods and steps described above indicate certain events occurring in certain order, it is intended that certain steps do not have to be performed in the order described but in any order as long as the steps allow the embodiments to function for their intended purposes. Therefore, to the extent there are variations of the invention, which are within the spirit of the disclosure or equivalent to the inventions found in the claims, it is the intent that this patent will cover those variations as well.

1. An analyte measurement system comprising:
a test strip including:
a substrate;
a plurality of electrodes connected to respective electrode connectors; and
an analyte meter including:
a housing;
a test strip port connector configured to connect to the respective electrode connectors of the test strip; and
a microprocessor in electrical communication with the test strip port connector to apply electrical signals or sense electrical signals from the plurality of electrodes during a test sequence,
wherein the microprocessor may be configured, during the test sequence, to:
(a) start an analyte test sequence upon deposition of a sample;
(b) apply a signal to the sample to determine a physical characteristic signal representative of the sample;
(c) drive another signal to the sample;
(d) measure at least one output signal from at least one of the electrodes;
(e) measure a temperature of one of the sample, test strip, or meter;
(f) determine a temperature compensated value for the physical characteristic signal based on the measured temperature;
(g) derive an estimated analyte concentration from the at least one output signal at one of a plurality of predetermined time intervals as referenced from the start of the test sequence;
(h) determine a temperature compensated value for the estimated analyte concentration based on the measured temperature;
(i) select an analyte measurement sampling time point or time interval with respect to the start of the test sequence based on (1) the temperature compensated value of the physical characteristic signal and (2) the temperature compensated value of the estimated analyte concentration;
(j) calculate an analyte concentration based on a magnitude of the output signals at the selected analyte measurement sampling time point or time interval; and
(k) annunciate the analyte concentration.

2. An analyte measurement system comprising:
a test strip including:
a substrate;
a plurality of electrodes connected to respective electrode connectors; and
an analyte meter including:
a housing;
a test strip port connector configured to connect to the respective electrode connectors of the test strip; and
a microprocessor in electrical communication with the test strip port connector to apply electrical signals or sense electrical signals from the plurality of electrodes during a test sequence,
wherein the microprocessor is configured, during the test sequence, to:
(a) start an analyte test sequence upon deposition of a sample;
(b) apply a signal to the sample to determine a physical characteristic signal of
the sample;
(c) drive another signal to the sample;
(d) measure at least one output signal from at least one of the electrodes;
(e) measure a temperature of one of the sample, test strip, or meter;
(f) derive an estimated analyte concentration from the at least one output signal at one of a plurality of predetermined time intervals as referenced from the start of the test sequence;
(g) selecting an analyte measurement sampling time point or time interval with respect to the start of the test sequence based on:
(1) the measured temperature,
(2) the physical characteristic signal,
(3) the estimated analyte concentration;
(i) calculate an analyte concentration based on a magnitude of the output signals at the selected analyte measurement sampling time point or time interval; and
(j) annunciate the analyte concentration.

3. An analyte measurement system comprising:
a test strip including:
a substrate;
a plurality of electrodes connected to respective electrode connectors; and
an analyte meter including:
a housing;
a test strip port connector configured to connect to the respective electrode connectors of the test strip; and
a microprocessor in electrical communication with the test strip port connector to apply electrical signals or sense electrical signals from the plurality of electrodes during a test sequence,
wherein the microprocessor is configured, during the test sequence, to:
(a) start an analyte test sequence upon deposition of a sample;
(b) apply a signal to the sample to determine a physical characteristic signal of
the sample;
(c) drive another signal to the sample;
(d) measure at least one output signal from at least one of the electrodes;
(e) measure a temperature of one of the sample, test strip, or meter;
(f) derive an estimated analyte concentration from the at least one output signal at one of a plurality of predetermined time intervals as referenced from the start of the test sequence;
(g) determine whether the measured temperature is in one of a plurality of temperature ranges;
(h) select an analyte measurement sampling time based on the estimated analyte concentration and the physical characteristic signal representative of the sample in a selected one of a plurality of temperature ranges;
(i) calculate an analyte concentration based on a magnitude of the output signals at the analyte measurement sampling time or time interval from the selected analyte measurement sampling time map; and
(j) annunciate the analyte concentration.

4. The measurement system of claim 3, in which each temperature range of the plurality of temperature ranges comprises a plurality measurement sampling times correlated to respective estimated analyte values and physical characteristics signals.

5. The system of claim 3, in which the plurality of electrodes comprises at least two electrodes to measure the physical characteristic signal and at least two other electrodes to measure the analyte concentration.

6. The system of claim 3, in which the at least two electrodes and the at least two other electrodes are disposed in the same chamber provided on the substrate.

7. The system of claim 3, in which the plurality of electrodes comprises two electrodes to measure the physical characteristic signal and the analyte concentration.

8. The system of claim 3, in which all of the electrodes are disposed on the same plane defined by the substrate.

9. The system of claim 3, in which a reagent may be disposed proximate the at least two other electrodes and no reagent may be disposed on the at least two electrodes.

10. The system of claim 3, in which the one of the plurality of predetermined time intervals for measuring at least one output signal during the test sequence may be about 2.5 seconds after the start of the test sequence.

11. The system of claim 3, in which the one of the plurality of predetermined time intervals comprises a time interval that overlaps a time point of 2.5 seconds after the start of the test sequence.

12. The system of claim 3, in which the other one of the plurality of predetermined time intervals for measuring at least one output signal during the test sequence may be a time point of about 5 seconds after a start of the test sequence.

13. The system of claim 3, in which the one of the plurality of predetermined time intervals comprises any time point at less than five seconds from a start of the test sequence.

14. The system of claim 3, in which the other one of the plurality of predetermined time intervals comprises any time point at less than ten seconds from a start of the test sequence.

15. The system of claim 3, in which the one of the plurality of predetermined time intervals comprises a time interval overlapping a time point of 2.5 seconds after the start of the test sequence and the other of the plurality of predetermined time intervals comprises a time interval overlapping a time point of 5 seconds after the start of the test sequence.

16. A glucose meter comprising:
a housing;
a test strip port connector configured to connect to respective electrical connectors of a biosensor; and
means for:
(a) applying first and second input signals to a sample deposited on the biosensor during a test sequence;
(b) measuring a physical characteristic signal representative of the sample from output signals of one of the first and second input signals;
(c) measuring a temperature of one of the biosensor or the meter;
(d) deriving an estimated a glucose concentration at one of a plurality of predetermined time intervals as referenced from the start of the test sequence based on the other of the first and second input signals;
(e) determining a measurement sampling time based on the measured temperature, physical characteristic signal and the estimated glucose concentration; and
(f) calculating a glucose concentration based on the measurement sampling time; and
an annunciator to provide an output of the glucose concentration from said means.

17. The meter of claim 16, in which the means for measuring includes means for applying a first alternating signal to the biosensor and for applying a second constant signal to the biosensor.

18. The meter of claim 16, in which the means for deriving includes means for estimating an analyte concentration based on a predetermined analyte measurement sampling time point from the start of the test sequence.

19. The meter of claim 16, in which the means for deriving comprises means to correlate the physical characteristic signal to the estimated glucose concentration and the measured temperature.

20. The meter of claim 17, in which the predetermined analyte measurement sampling time interval comprises a time interval at about 2.5 seconds from the start of the test sequence.

21. A method of determining an analyte concentration from a fluid sample with a test strip having at least two electrodes and a reagent disposed on at least one of the electrodes, the method comprising:
depositing a fluid sample on any one of the at least two electrodes to start an analyte test sequence;
applying a first signal to the sample to measure a physical characteristic of the sample;
driving a second signal to the sample to cause an enzymatic reaction of the analyte and the reagent;
estimating an analyte concentration based on a predetermined sampling time point from the start of the test sequence;
measuring temperature of at least one of the biosensor or ambient environment;
obtaining a look up table from a plurality of look-up table indexed to the measured temperature, each look-up table having different qualitative categories of the estimated analyte and different qualitative categories of the measured or estimated physical characteristic indexed against different sampling time points;
selecting a sampling time point from the look-up table obtained in the obtaining step;
sampling signal output from the sample at the selected measurement sampling time from the look-up table obtained in the obtaining step;
calculating an analyte concentration from measured output signal sampled at said selected measurement sampling time in accordance with an equation of the form:
$${G}_{0} = [ \frac{{I}_{T} - Intercept}{Slope} ]$$
where
G₀ represents an analyte concentration;
I_{T} represents a signal (proportional to analyte concentration) measured at the selected sampling time T;
Slope represents the value obtained from calibration testing of a batch of test strips of which this particular strip comes from; and
Intercept represents the value obtained from calibration testing of a batch of test strips of which this particular strip comes from.

22. A method of determining an analyte concentration from a fluid sample, the method comprising:
depositing a fluid sample on a biosensor to start a test sequence;
causing the analyte in the sample to undergo an enzymatic reaction;
estimating an analyte concentration in the sample;
measuring at least one physical characteristic of the sample;
measuring temperature of at least one of the biosensor or ambient environment;
obtaining a look up table from a plurality of look-up table indexed to the measured temperature, each look-up table having different qualitative categories of the estimated analyte and different qualitative categories of the measured or estimated physical characteristic indexed against different sampling time points;
selecting a sampling time point from the look-up table obtained in the obtaining step;
sampling signal output from the sample at the selected measurement sampling time from the look-up table obtained in the obtaining step; and
determining an analyte concentration from sampled signals at the selected measurement sampling time.

23. The method of claim 21, in which the measuring comprises applying a first signal to the sample to measure a physical characteristic of the sample; the causing step comprises driving a second signal to the sample; the measuring comprises evaluating an output signal from at least two electrodes of the biosensor at the selected measurement sampling time after the start of the test sequence, in which the time is set as a function of at least the measured or estimated physical characteristic and the estimated analyte concentration.

24. The method of claim 22, further comprising estimating an analyte concentration based on a predetermined sampling time point from the start of the test sequence.

25. The method of claim 23, in which the defining comprises selecting a defined time point based on both the measured or estimated physical characteristic and the estimated analyte concentration from the estimating step.

26. The method of claim 22, further comprising estimating an analyte concentration based on a measurement of the output signal at a predetermined time.

27. The method of claim 26, in which the predetermined time comprises about 2.5 seconds from the start of the test sequence.

28. The method of claim 26, in which the calculating step comprises utilizing an equation of the form:
$${G}_{0} = [ \frac{{I}_{T} - Intercept}{Slope} ]$$
where
G₀ represents an analyte concentration;
I_{T} represents a signal (proportional to analyte concentration) measured at a specified sampling time T;
Slope represents the value obtained from calibration testing of a batch of test strips of which this particular strip comes from; and
Intercept represents the value obtained from calibration testing of a batch of test strips of which this particular strip comes from.

29. The method of claim 28, in which the applying of the first signal and the driving of the second signal is sequential.

30. The method of claim 28, in which the applying of the first signal overlaps with the driving of the second signal.

31. The method of claim 30, in which the applying of the first signal comprises directing an alternating signal to the sample so that a physical characteristic of the sample is determined from an output of the alternating signal.

32. The method of claim 31, in which the applying of the first signal comprises directing an electromagnetic signal to the sample so that a physical characteristic of the sample is determined from an output of the electromagnetic signal.

33. The method of claim 22, in which the physical characteristic comprises at least one of viscosity, hematocrit, temperature and density.

34. The method claim 22, in which the physical characteristic comprises hematocrit and the analyte comprises glucose.

35. The method of claim 22, in which the directing comprises driving first and second alternating signal at different respective frequencies in which a first frequency is lower than the second frequency.

36. The method of claim 34, in which the first frequency is at least one order of magnitude lower than the second frequency.

37. The method of claim 34, in which the first frequency comprises any frequency in the range of about 10 kHz to about 250 kHz.

38. The method of claim 22, in which the sampling comprises sampling the signal output continuously at the start of the test sequence until at least about 10 seconds after the start.
